(19) United States
(12) Patent Application Publication
(10) Pub. No.: US 2011/0239163 A1
(43) Pub. Date: Sep. 29, 2011

(54) DISPLAY SCREEN CONTROL METHOD, GRAPHICAL USER INTERFACE, INFORMATION PROCESSING APPARATUS, INFORMATION PROCESSING METHOD, AND PROGRAM

(76) Inventors: Daisuke MOCHIZUKI, Chiba (JP); Tomohiko GOTOH, Kanagawa (JP); Yuki OKAMURA, Saitama (JP); Tatsuhito SATO, Kanagawa (JP)

(21) Appl. No.: 12/915,905

(22) Filed: Oct. 29, 2010

(30) Foreign Application Priority Data
Dec. 4, 2009 (JP) P2009-277081
Dec. 4, 2009 (JP) P2009-277082

(51) Int. Cl. G06F 3/048

(52) U.S. Cl. 715/853

(57) ABSTRACT

There is provided an information processing apparatus including a tree structure generation unit that generates a tree structure in which a leaf node represents content data associated with position information, serving as metadata, representing a location of a feature space defined based on a predetermined feature quantity, and a set of nodes whose distance in the feature space satisfies a predetermined condition is defined as a parent node of the nodes satisfying the predetermined condition, and a node extraction unit that, when any position information is specified, identifies a node in the tree structure to which the specified position information belongs, and extracts, according to a position of the identified node in the tree structure, one or a plurality of nodes, other than the node to which the specified position information belongs, from among the nodes in the tree structure.

### BACKGROUND OF THE INVENTION

1. Field of the Invention

The present invention relates to a display screen control method, a graphical user interface, an information processing apparatus, an information processing method, and a program.

2. Description of the Related Art

A technique for generating a group including data located closely from each other in a feature space defined by a predetermined feature quantity is called clustering. The clustering is widely used in various fields. Generation of a data structure having a tree structure is widely performed by further classifying, into groups, data included in each cluster generated by clustering.

The data structure thus generated is structured such that a higher level includes lower levels. Accordingly, this is used for the purpose of searching for desired data by selecting groups, one by one in order from a coarse-grained group to a fine-grained group, and for the purpose of grouping various granularities by changing levels when certain data are grouped (for example, see Japanese Patent Application Laid-Open No. 2007-122562).

When a user searches for data classified into groups, the data are often searched for by sequentially tracing, from the top in order, a hierarchical structure formed by clustering operation. Japanese Patent Application Laid-Open No. 2007-122562 indicates that a display screen allowing a user to intuitively understand a hierarchical structure is provided to allow the user to easily execute data search.

The search method such as the one described in Japanese Patent Application Laid-Open No. 2007-122562 is effective when data to be searched for are known. However, for example, when a user wants to search for a content similar to certain content data such as a picture, it is more convenient if the user can view and search for data based on data in question.

Accordingly, applications and services for displaying a list of contents based on a specified position have been recently developed.

### SUMMARY OF THE INVENTION

The above-explained application for displaying a list of contents based on a specified position is configured to display all contents on a display screen. Therefore, there is an issue in that the display screen becomes complicated.

In view of the foregoing, it is desirable to provide a display screen control method and a graphical user interface capable of providing information about contents without making a display screen complicated.

In some cases, it may be desired to classify data into groups as follows: a certain position is used as a reference, and data located closer to the reference position are divided with a fine granularity, whereas data located farther are grouped with a coarse granularity. This kind of grouping can be achieved by performing clustering operation in view of not only absolute positions of data in a feature space but also distances from a particular position to data.

However, when a large amount of data are particularly necessary, the clustering needs equal amount of calculation. Accordingly, when data are classified into groups according to a specified position which changes from time to time, it is necessary to execute clustering again on every specified position. Therefore, there is an issue in that a heavy load is imposed upon an apparatus performing clustering operation.

Further, in view of the foregoing, it is desirable to provide an information processing apparatus, an information processing method, and a program capable of performing clustering operation for changing a cluster granularity based on a distance from a particular position in a feature space while suppressing a load necessary for the clustering.

According to an embodiment of the present invention, there is provided a display screen control method including the steps of generating a tree structure in which a leaf node represents content data associated with position information, serving as metadata, representing a location of a feature space defined based on a predetermined feature quantity, and a set of nodes whose distance in the feature space satisfies a predetermined condition is defined as a parent node of the nodes satisfying the predetermined condition, when any position information serving as a reference is specified, identifying a node in the tree structure to which the specified position information belongs, extracting, according to a position of the identified node in the tree structure, one or a plurality of nodes, other than the node to which the reference position information belongs, from among the nodes in the tree structure, and using a node extraction result obtained in the step of extracting the node to display an object corresponding to the content data at a position in a display screen according to the position information. In the step of identifying the node and in the step of extracting the node, a position corresponding to a center of the display screen is used as the position information serving as the reference, in the step of displaying the object, in a case where there is content data in which a position corresponding to the position information is out of a range displayed in the display screen, a node including the content data located out of the range is selected from among the extraction result, and an object corresponding to the selected node is displayed as an object of the content data located out of the range.

In the step of displaying the object, in a case where the object corresponding to the node is displayed, a direction instruction object may be displayed together with the object corresponding to the node, the direction instruction object indicating a direction of a position corresponding to the position information associated with the node.

In the step of displaying the object, in a case where the direction instruction object is selected by user operation, the display screen may be changed so that a central position of the node corresponding to the direction instruction object or a position of the content data located at a position closest to the central position of the node is arranged in the center of the display screen.

In the step of displaying the object, a size of a region displayed in the display screen may be determined so that other nodes or content data included in the node are all displayed within the display screen.

In the step of displaying the object, the node selected from among the extraction result may be changed according to a size of a region displayed in the display screen.

Sizes of the direction instruction object and the object corresponding to the node may be determined according to a distance between the node and a position corresponding to the center of the display screen or the number of content data or other nodes included in the node.

According to another embodiment of the present invention, there is provided a graphical user interface including a display region for displaying an execution screen of an application for displaying, at a display position corresponding to position information, an object corresponding to content data associated with the position information, serving as metadata, representing a location of a feature space defined based on a predetermined feature quantity. The content data are clustered into one or a plurality of groups based on the position information in advance, and a display state of the object in the execution screen changes according to a clustering result and a distance between a position corresponding to the position information and a central position of the execution screen.

According to another embodiment of the present invention, there is provided an information processing apparatus including a tree structure generation unit that generates a tree structure in which a leaf node represents content data associated with position information, serving as metadata, representing a location of a feature space defined based on a predetermined feature quantity, and a set of nodes whose distance in the feature space satisfies a predetermined condition is defined as a parent node of the nodes satisfying the predetermined condition, and a node extraction unit that, when any position information is specified, identifies a node in the tree structure to which the specified position information belongs, and extracts, according to a position of the identified node in the tree structure, one or a plurality of nodes, other than the node to which the specified position information belongs, from among the nodes in the tree structure.

The node extraction unit preferably extracts, from among the nodes in the tree structure, all child nodes of the identified node and nodes, other than the identified node, branching from a parent node of the identified node.

The node extraction unit may newly adopt, as a new target node, a parent node having a child node, other than the identified node, branching from the identified node and a parent node of the identified node, and further extracts a node, other than the target node, branching from a parent node of the target node.

The node extraction unit may repeat node extraction until the target node becomes a root node.

In a case where the specified position information belongs to a plurality of nodes in the tree structure, the node extraction unit may adopt, as a node to which the specified position information belongs, a node located at a deepest position with respect to the root node from among the plurality of nodes.

In a case where the specified position information further includes information for specifying a region in the feature space, the node extraction unit may change an extracted node according to a size of an area of the region.

The feature space may be a space representing a location on a surface of a sphere defined by a latitude and a longitude.

The feature space may be a space defined based on a feature quantity for specifying a location on a plane.

The feature space may be a space defined based on a feature quantity for specifying a time.

According to another embodiment of the present invention, there is provided an information processing method, including the steps of generating a tree structure in which a leaf node represents content data associated with position information, serving as metadata, representing a location of a feature space defined based on a predetermined feature quantity, and a set of nodes whose distance in the feature space satisfies a predetermined condition is defined as a parent node of the nodes satisfying the predetermined condition, identifying a node in the tree structure to which any specified position information belongs, and extracting, according to a position of the identified node in the tree structure, one or a plurality of nodes, other than the node to which the specified position information belongs, from among the nodes in the tree structure.

According to another embodiment of the present invention, there is provided a program for causing a computer to realize a tree structure generation function for generating a tree structure in which a leaf node represents content data associated with position information, serving as metadata, representing a location of a feature space defined based on a predetermined feature quantity, and a set of nodes whose distance in the feature space satisfies a predetermined condition is defined as a parent node of the nodes satisfying the predetermined condition, and a node extraction function for, when any position information is specified, identifying a node in the tree structure to which the specified position information belongs, and extracting, according to a position of the identified node in the tree structure, one or a plurality of nodes, other than the node to which the specified position information belongs, from among the nodes in the tree structure.

As explained above, according to the present invention, information about contents can be provided without making a display screen complicated.

Further, according to the present invention, clustering for changing a cluster granularity can be performed based on a distance from a particular position in a feature space while suppressing a load necessary for the clustering.

### BRIEF DESCRIPTION OF THE DRAWINGS

FIG. 1 is an explanatory diagram illustrating a tree structure;

FIG. 2 is an explanatory diagram illustrating an example of clustering carried out by an information processing apparatus according to a first embodiment of the present invention;

FIG. 3 is a block diagram illustrating a configuration of an information processing apparatus according to the embodiment;

FIG. 4 is an explanatory diagram illustrating a method for generating clusters;

FIG. 5A is an explanatory diagram illustrating a method for generating clusters;

FIG. 5B is an explanatory diagram illustrating a method for generating clusters;

FIG. 5C is an explanatory diagram illustrating a method for generating clusters;

FIG. 6A is an explanatory diagram illustrating a method for generating clusters;

FIG. 6B is an explanatory diagram illustrating a method for generating clusters;

FIG. 6C is an explanatory diagram illustrating a method for generating clusters;

FIG. 6D is an explanatory diagram illustrating a method for generating clusters;

FIG. 6E is an explanatory diagram illustrating a method for generating clusters;

FIG. 7 is an explanatory diagram illustrating a method for generating clusters;

FIG. 8A is an explanatory diagram illustrating distances among clusters;

FIG. 8B is an explanatory diagram illustrating distances among clusters;

FIG. 8C is an explanatory diagram illustrating distances among clusters;

FIG. 9 is an explanatory diagram illustrating a method for generating clusters;

FIG. 10 is an explanatory diagram illustrating metadata associated with a cluster;

FIG. 11 is an explanatory diagram illustrating an information processing method according to the embodiment;

FIG. 12 is an explanatory diagram illustrating an example of a tree structure data according to the embodiment;

FIG. 13 is an explanatory diagram illustrating an example of a tree structure data according to the embodiment;

FIG. 14 is an explanatory diagram illustrating an example of a tree structure data according to the embodiment;

FIG. 15 is an explanatory diagram illustrating an example of a tree structure data according to the embodiment;

FIG. 16 is an explanatory diagram illustrating an example of a tree structure data according to the embodiment;

FIG. 17 is an explanatory diagram illustrating an example of a tree structure data according to the embodiment;

FIG. 18 is an explanatory diagram illustrating an information processing method according to the embodiment;

FIG. 19 is a flow diagram illustrating a node extraction method according to the embodiment;

FIG. 20 is a flow diagram illustrating a node extraction method according to the embodiment;

FIG. 21 is an explanatory diagram illustrating an example of a display screen of the information processing apparatus according to the embodiment;

FIG. 22A is an explanatory diagram illustrating an example of a display screen control method according to the embodiment;

FIG. 22B is an explanatory diagram illustrating an example of a display screen control method according to the embodiment;

FIG. 22C is an explanatory diagram illustrating an example of a display screen control method according to the embodiment;

FIG. 23A is an explanatory diagram illustrating an example of a display screen control method according to the embodiment;

FIG. 23B is an explanatory diagram illustrating an example of a display screen control method according to the embodiment;

FIG. 24 is an explanatory diagram illustrating an example of a display screen control method according to the embodiment;

FIG. 25 is an explanatory diagram illustrating an example of a display screen control method according to the embodiment;

FIG. 26 is a flow diagram illustrating a display screen control method according to the embodiment; and

FIG. 27 is a block diagram illustrating a hardware configuration of an information processing apparatus according to an embodiment of the present invention.

### DETAILED DESCRIPTION OF THE EMBODIMENT

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

The following explanation will be made in an order described below.

(1) Tree structure

(2) First Embodiment
(2-1) Overview of clustering achieved by information processing apparatus
(2-2) Configuration of information processing apparatus
(2-3) Node extraction method
(2-4) Example of display screen
(2-5) Display screen control method

(3) Hardware configuration of information processing apparatus according to embodiment of the present invention

### (Tree Structure)

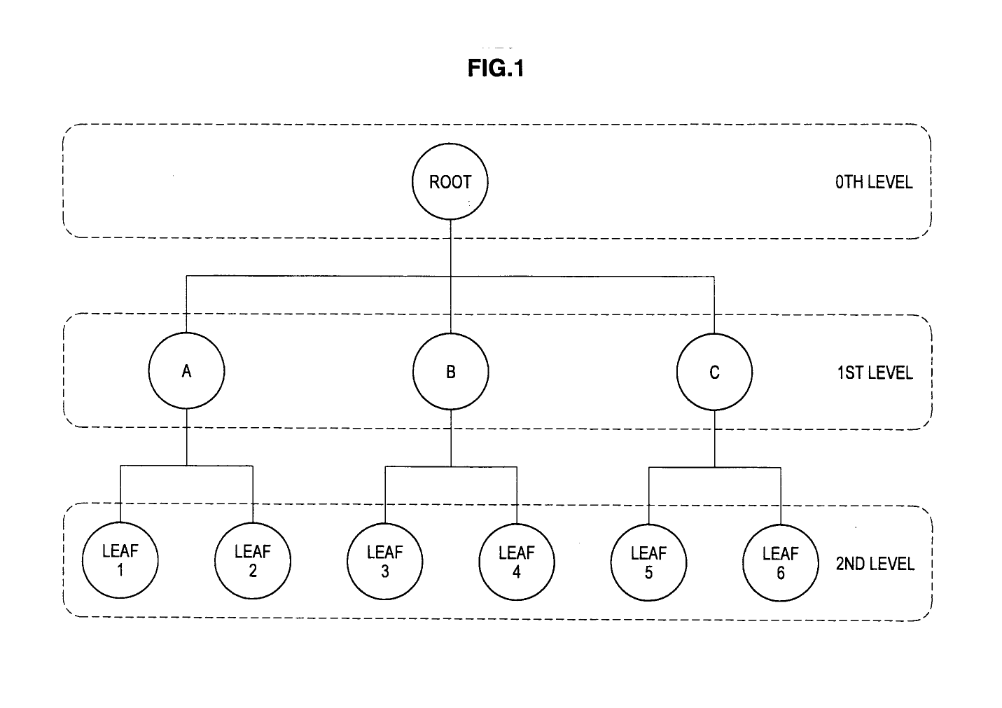

First, terms relating to a tree structure used in this specification will be briefly explained with reference to FIG. 1 before explaining an embodiment of the present invention. FIG. 1 is an explanatory diagram illustrating a tree structure.

For example, as shown in FIG. 1, a tree structure is constituted by a plurality of elements (those indicated by circles in FIG. 1). The plurality of elements are referred to as nodes. In the tree structure, a node located at the top is referred to as a root node. From the viewpoint of the root node, branching-off occurs from the root node in a downward direction of the figure, and a node is located at an end of each branch. By repeating such branching-off, the tree structure achieves a multi-level structure as shown in FIG. 1. In the tree structure, a node located at the bottom is referred to as a leaf node. As is evident from the figure, branching-off does not occur from these leaf nodes.

Now, attention is paid to a node “B” shown in FIG. 1. A branch extending upward from the node B is connected to the root node. A branch extending downward from the node B is connected to two nodes (leaf nodes), i.e., a leaf 3 and a leaf 4. A node directly connected to a branch extending in an upward direction (in other words, in the direction of the root node), such as the root node with respect to the node B, is referred to as a parent node. A node directly connected to a branch extending in a downward direction (in other words, in the direction opposite to the direction of the root node), such as the leaf 3 and the leaf 4 with respect to the node B, is referred to as a child node.

Whether a node is called a parent node or a child node is determined in a relative manner, and when attention is paid to a different node, the way it is called changes accordingly. For example, from the viewpoint of the leaf 3 or the leaf 4, the node B is a parent node. However, from the viewpoint of the root node, the node B is a child node.

The tree structure has a multi-level structure as shown in FIG. 1, in which a level including the root node is referred to as the 0th level, a level including a child node of the root node is referred to as the 1st level, and a level including a child node of a node of the 1st level is referred to as the 2nd level in the explanation below. In the explanation below, subsequent levels are respectively referred to as the 3rd level, the 4th level, and so on, as necessary.

A child node other than a target node branched from a certain parent node is referred to as a sibling node. For example, a node A and a node C are referred to as sibling nodes when attention is paid to the node B. For example, in FIG. 1, when attention is paid to the leaf 3, a sibling node thereof is the leaf 4.

In the example shown in FIG. 1, a plurality of branches are branched off from a certain node. Alternatively, there may be only one branch extending in the downward direction (the direction opposite to the direction of the root node) from the node. It is to be understood that the number of branches branched off from a certain node is not limited to the example shown in FIG. 1.

### First Embodiment

### Overview of Clustering Realized by Information Processing Apparatus

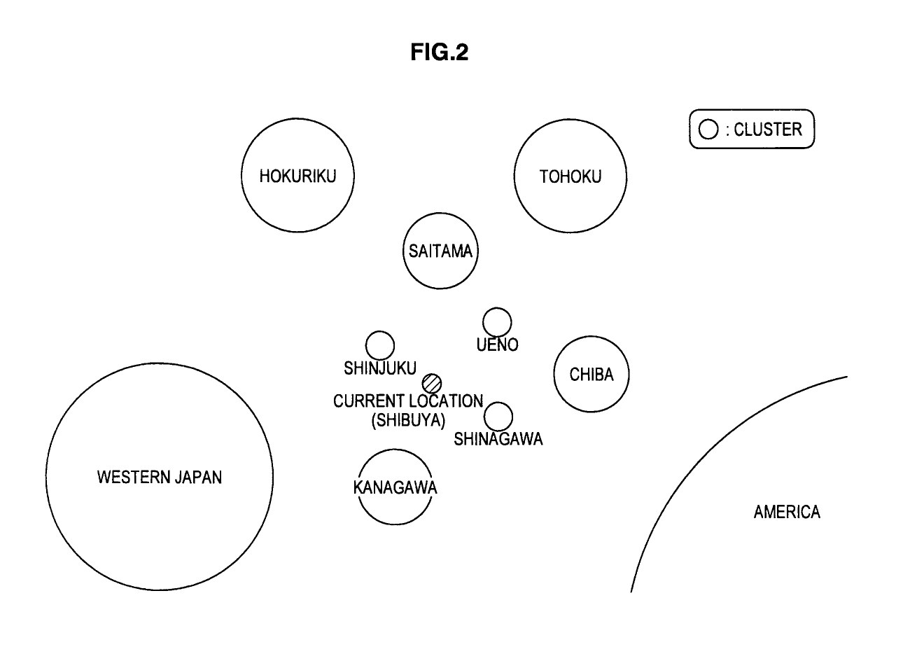

First, overview of clustering achieved by an information processing apparatus according to the first embodiment of the present invention will be briefly explained with reference to FIG. 2. FIG. 2 is an explanatory diagram illustrating an example of clustering carried out by an information processing apparatus according to the present embodiment.

As explained above, in some cases, it may be desired to classify data into groups (clustering) as follows: a certain position is used as a reference, and data located closer to the reference position are divided with a fine granularity, whereas data located farther are grouped with a coarse granularity.

For example, an apparatus for displaying recommended spots around a current location on a map will be considered. In this case, spots located in proximity to the current location are displayed without being classified into groups (alternatively, they are classified into groups in such a manner that 1 piece of data corresponds to 1 group). Spots somewhat away from the current location are displayed in such a manner that they are classified into groups by municipalities. Spots in far away foreign countries are displayed in such a manner that the spots are classified into groups by country.

In the example shown in FIG. 2, the current location is around Shibuya, Tokyo, and a result of grouping is shown while granularities of groups (clusters) are changed according to distances from Shibuya. Clusters representing locations such as “Shinjuku”, “Ueno”, and “Shinagawa”, namely, groups (clusters) located in proximity to the current location, i.e., Shibuya, are displayed with a fine granularity. It can be seen that the farther the cluster is located from the current location, the coarser the granularity of the cluster.

When this kind of display is provided by the apparatus, the user can roughly, easily understand the arrangement of the displayed clusters. Therefore, if the above-explained apparatus can be realized, the convenience of the user can be improved as a result.

When it is desired that the sizes of groups are classified according to distances from a specified position as shown in the above example, such grouping can be achieved by performing clustering operation in view of not only absolute positions of data in a feature space but also distances to data from the particular position.

However, when the amount of data is particularly large, a heavy load of calculation is imposed in the clustering. Therefore, when spots are classified into groups according to the current location as shown in the above example, the system is forced to bear a heavy load upon re-execution of clustering on every current location changing from time to time.

In a case of clustering based on an actual current location, it is difficult to move so fast in the real world, for example. Accordingly, operation may be performed such that, for example, the current location is changed every one minute. In contrast, when the same thing as the above example is performed in a virtual world, it is difficult to imagine when and how much a particular location changes. In this case, it is difficult to achieve such clustering.

Accordingly, in an information processing apparatus according to the present embodiment explained below, clustering is performed to generate a multi-level cluster structure having different cluster granularities, and a tree structure representing the cluster structure is generated. Further, when a certain position is specified in a feature space defining the cluster structure, the specified position and the generated cluster structure are used to extract a desired cluster from various levels. Therefore, the information processing apparatus according to the present embodiment can perform clustering for changing a cluster granularity while suppressing a load imposed on clustering, based on a distance from the particular position in the feature space.

### <Configuration of Information Processing Apparatus>

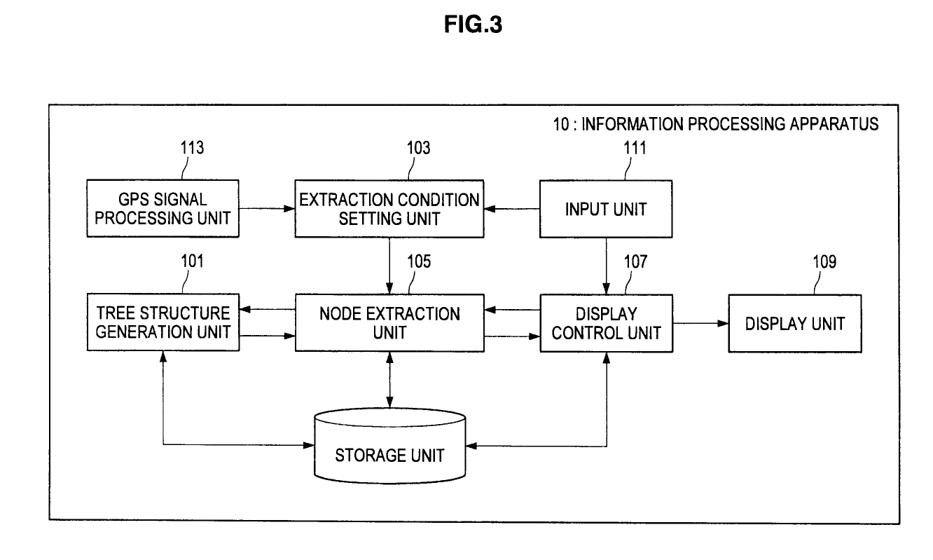

Subsequently, a configuration of the information processing apparatus according to the first embodiment of the present invention will be explained in detail with reference to FIG. 3. FIG. 3 is a block diagram illustrating the configuration of the information processing apparatus according to the embodiment.

Examples of content data handled by the information processing apparatus 10 according to the present embodiment include image contents such as still picture contents and motion picture contents, and various kinds of text information, image information, and the like which are registered to servers and the like for sharing various kinds of information with users. In addition to the above data, the information processing apparatus 10 can be applied to contents such as mails, music, schedule, electronic money use history, telephone history, content viewing history, sightseeing information, local information, news, weather forecast, and ringtone mode history.

In the explanation below, image contents such as still picture contents and motion picture contents are explained, for example. However, the information processing apparatus 10 according to the present embodiment can handle any information and content data as long as position information representing a location in a feature space is attached as metadata with the data.

Preferably, the content data and data representing various kinds of information are stored in the information processing apparatus 10. Alternatively, main data may be stored in an apparatus such as a server arranged outside the information processing apparatus 10, and metadata corresponding to the main data may be stored in the information processing apparatus 10. For example, in the explanation below, the information processing apparatus 10 stores content data and data representing various kinds of information together with metadata.

For example, as shown in FIG. 3, the information processing apparatus 10 according to the present embodiment mainly includes a tree structure generation unit 101, an extraction condition setting unit 103, a node extraction unit 105, a display control unit 107, a display unit 109, an input unit 111, a GPS signal processing unit 113, and a storage unit 115.

The tree structure generation unit 101 is realized with, for example, a CPU (Central Processing Unit), ROM (Read Only Memory), RAM (Random Access Memory), and the like. The tree structure generation unit 101 generates a tree structure in which a leaf node represents content data associated with position information, serving as metadata, representing a location of a feature space defined based on a predetermined feature quantity, and a set of nodes satisfying a predetermined condition in the feature space is defined as a parent node of the nodes satisfying the predetermined condition.

First, the position information associated with the content data will be explained.

The tree structure generation unit 101 according to the present embodiment assumes the feature space defined by the predetermined feature quantity, based on the predetermined feature quantity described in the metadata associated with the content data. Examples of predetermined feature quantities described in metadata include information about latitude/longitude for identifying a location where a content is generated, information about a time when a content is generated, and information about an address representing a location where a content is generated. The metadata of the above predetermined feature quantities may be stored in, for example, an Exif (Exchangeable Image File Format) tag and the like associated with the content data.

The information about latitude/longitude for identifying a location is information which can be obtained by obtaining and analyzing a GPS signal, for example. Position information such as latitude/longitude is a feature quantity for identifying a position on a surface of an spherical object called earth (a position on a surface of a sphere). Accordingly, the feature space defined based on the information about the latitude/longitude is a space representing a position on the surface of the sphere called earth. Naturally, a position in this feature space can be defined by specifying each of a latitude and a longitude. Further, a distance between two positions in the feature space can be defined using a so-called ground distance.

Further, even in a case where information representing a location on the surface of the earth is used as a feature quantity, the surface of the sphere can be approximated as a flat surface when a local region is considered. Therefore, by adopting a latitude as an x coordinate and a longitude as a y coordinate, a feature space can also be defined. In this case, the feature space is a planar space (Euclidean space) defined by a two-dimensional vector such as (x, y), and a distance between two positions in the feature space can be defined by using a so-called Euclidean distance.

On the other hand, when information about a time when a content is generated is used as a feature quantity, the feature space is defined based on one-dimensional information, i.e., time. Therefore, in such case, the feature space is defined by time, i.e., scalar quantity, and a distance between two positions in the feature space is defined by a time difference.

The tree structure generation unit 101 assumes the feature space defined using the feature quantity as described above and generates a tree structure representing a clustering result of contents according to the degree of distribution of the contents within this feature space.

The tree structure generated by the tree structure generation unit 101 has the following features.

(1) Content data correspond to leaf nodes.
(2) Data closely located with each other in the feature space are included in the same node.
(3) When a node including data closely located with each other is present close to another node, these nodes are included in the same node.
(4) Nodes in the same level have relation in terms of the node size.

Further, the tree structure generated by the tree structure generation unit 101 may have the following feature in addition to the above features (1) to (4).

(5) A region of a certain node in a feature space and a region of another node in the feature space do not overlap unless the nodes are in parent-child relationship.

For example, the tree structure generation unit 101 generates the above-explained tree structure as follows.

First, the tree structure generation unit 101 references metadata associated with content data that can be used by the information processing apparatus 10, and arranges the content data on a plane surface in the feature space, based on position information described in the metadata. It should be noted that the arrangement of these contents are nothing but virtual.

Subsequently, the tree structure generation unit 101 calculates distances between data, for a set of content data in the plane. Subsequently, the tree structure generation unit 101 performs grouping (classification) by making a plurality of data located closely to each other into groups. The grouping processing carried out by the tree structure generation unit 101 can be called clustering. Further, each group made by this grouping processing (clustering) will be referred to a cluster.

The tree structure generation unit 101 classifies contents that can be used by the information processing apparatus 10 into a plurality of clusters by way of joining operation or separating operation of the clusters, thus generating a multi-level tree structure in which content data are represented by leaf nodes and the clusters are represented by nodes.

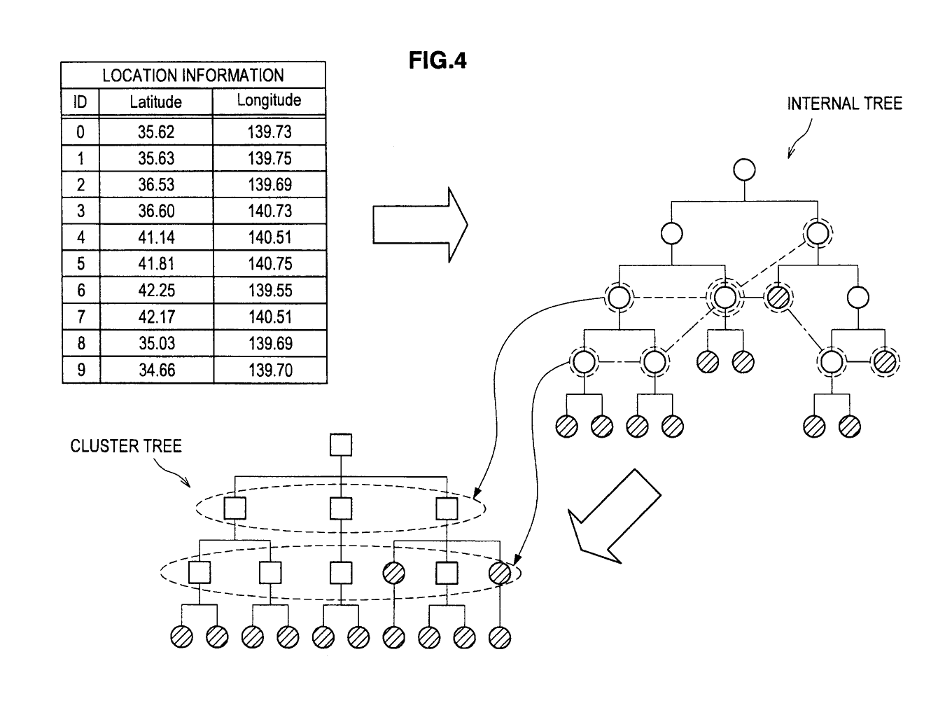

In the explanation below, a clustering method carried out by the tree structure generation unit 101 will be briefly explained with reference to FIG. 4 to FIG. 10.

The clustering method carried out by the tree structure generation unit 101 according to the present embodiment is performed according to a flow shown in FIG. 4. First, the tree structure generation unit 101 references position information associated with content data, and generates a tree structure called an internal tree as shown in an upper right portion of FIG. 4. Subsequently, the tree structure generation unit 101 restructures the generated internal tree based on a predetermined condition, thereby generating a cluster tree as shown in a lower portion of FIG. 4.

FIG. 4 shows position information using a latitude and a longitude as an example of position information associated with content data. In FIG. 4, those indicated by hatched circles correspond to the content data, and circles represent nodes (clusters) in the internal tree. Further, boxes represent clusters extracted by the node extraction unit 105 later explained.

First, processing for generating the internal tree will be explained.

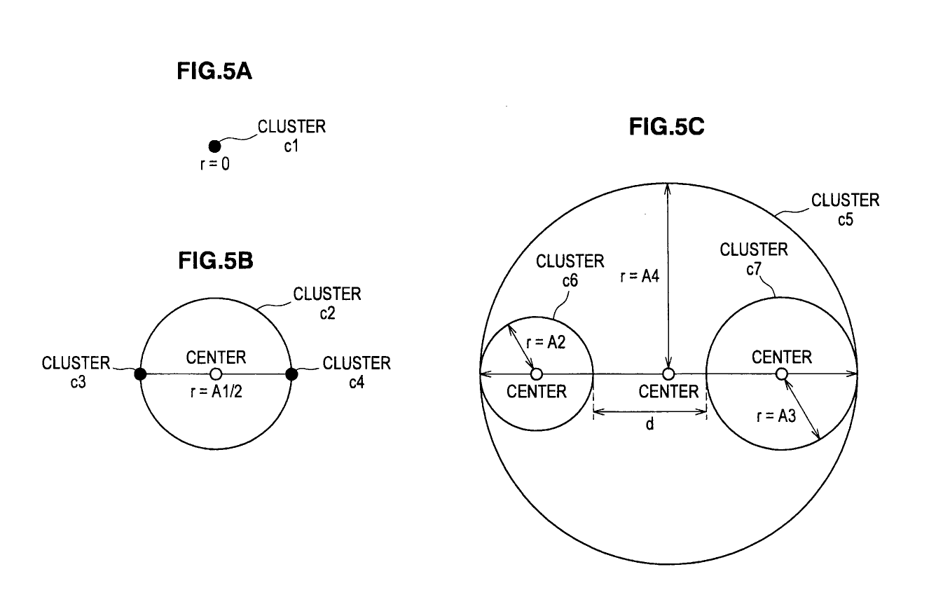

FIG. 5A to FIG. 5C are explanatory diagrams illustrating a method for generating clusters. FIG. 5A is a figure illustrating a case where one content belongs to a cluster c1. FIG. 5B is a figure illustrating a case where two clusters belong to a cluster c2. FIG. 5C is a figure illustrating a case where at least four clusters belong to a cluster c5.

It should be noted that the cluster c2 shown in FIG. 5B is constituted by clusters c3 and c4 each including one content, and the cluster c5 shown in FIG. 5C is constituted by clusters c6 and c7 each including at least two or more contents. In the explanation below, two-dimensionally arranged contents are clustered.

Each cluster generated after a plurality of contents are clustered is a circular region, which has a central position (central point) and a radius of the circle thereof as attribute values. As described above, a circular cluster region defined by a central point and a radius includes contents which belong to the cluster.

For example, as shown in FIG. 5A, in which only one content belongs to the cluster c1, the central position of the cluster c1 represents a position of the content which belongs to the cluster c1. Since the cluster c1 itself is constituted by only one point, the radius of the cluster c1 is 0 (r=0).

For example, as shown in FIG. 5B, in which two contents (clusters c3 and c4) belong to the cluster c2, the central position of the cluster c2 is located on a line connecting the positions of the two contents. More specifically, the central position of the cluster c2 is in the center of this line. The radius of the cluster c2 is half of the line connecting the positions of the two contents. For example, where the distance of the line connecting the clusters c3 and c4 corresponding to the two contents is A1, the radius r of the cluster c2 is A1/2.

In clustering, a distance between contents is calculated in order to obtain a distance between clusters each having only one content. For example, a distance between a position of a content belonging to the cluster c3 and a position of a content belonging to the cluster c4 is calculated in order to obtain a distance between the clusters c3 and c4.

For example, explained below is a case where at least four contents belong to the cluster c5 as shown in FIG. 5C. In this case, the central position of the cluster c5 is on a line connecting the central position of the cluster c6 and the central position of the cluster c7, namely, a position in the center of a line connecting a position at which the circle of the cluster c5 is in contact with the circle of the cluster c6 and a position at which the circle of the cluster c5 is in contact with the circle of the cluster c7. The radius of the cluster c5 is a value half of the line connecting the positions at which the circle of the cluster c5 is in contact with the circles of the clusters c6 and c7.

In clustering, a shortest distance between peripheries of the circles of the clusters is calculated in order to obtain a distance between clusters to which a plurality of contents belong. For example, a distance between the clusters c6 and c7 is a distance d shown in the figure. Where the radius of the cluster c6 is A2, the radius of the cluster c7 is A3, and the radius of the cluster c5 is A4, the distance d between the clusters c6 and c7 is 2 (A4−A2−A3).

A method for calculating a distance between clusters used by the tree structure generation unit 101 according to the present embodiment is not limited to the above method, and may be any method such as centroid method, shortest distance method, longest distance method, inter-group average distance method, and Ward method.

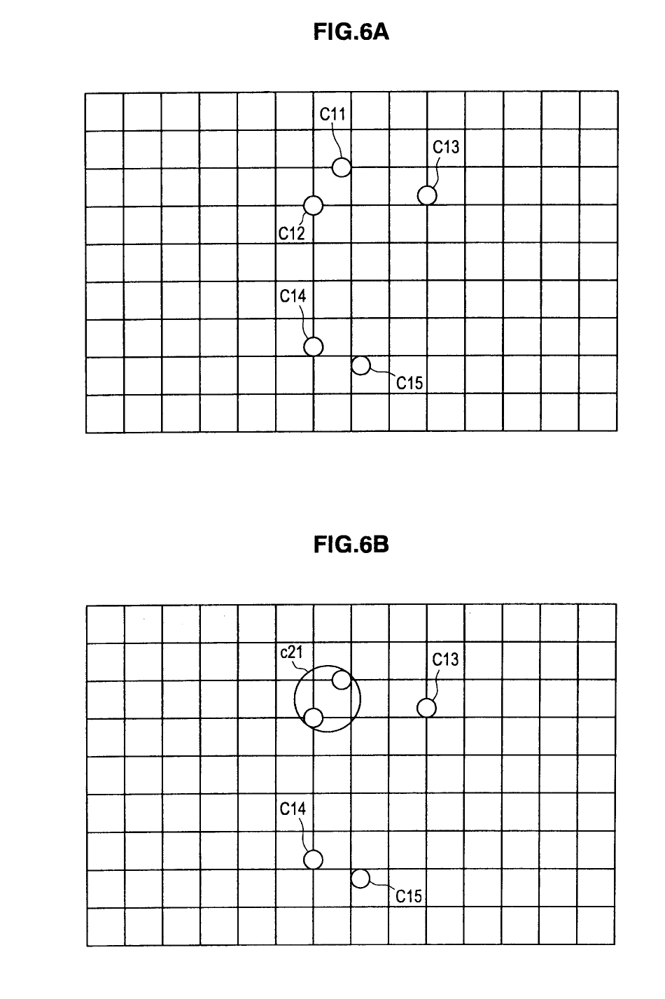

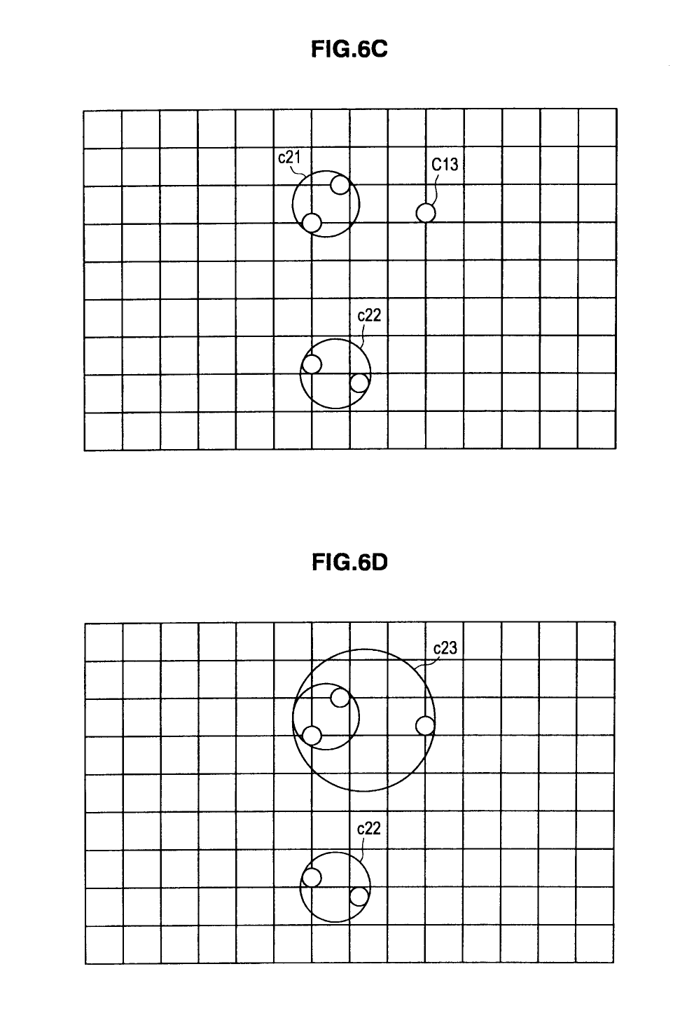

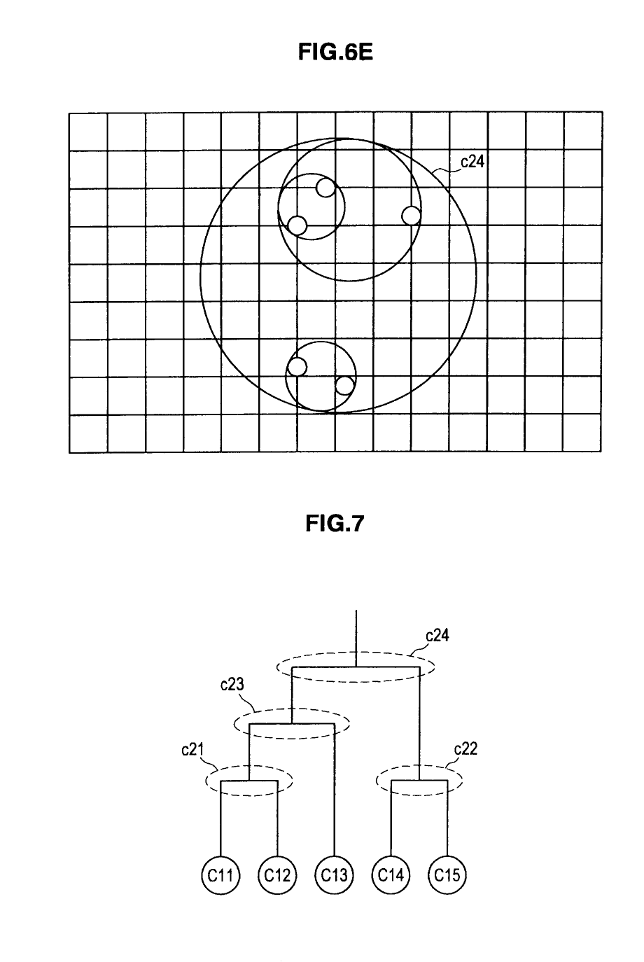

Subsequently, a specific example of clustering processing performed by the tree structure generation unit 101 will be explained with reference to FIG. 6A to FIG. 7. FIG. 6A to FIG. 7 are explanatory diagrams for illustrating a method for generating clusters (more specifically, a method for generating an internal tree). In FIG. 6A to FIG. 7, five contents C11 to C15 are clustered.

First, the tree structure generation unit 101 references position information associated with the five contents C11 to C15, and arranges these contents on a plane in a feature space (FIG. 6A). Subsequently, the tree structure generation unit 101 calculates distances between the contents. Based on this calculation result, the tree structure generation unit 101 makes a cluster c21 including a content C11 and a content C12, the distance between which is the shortest among the distances between the contents, by making the content C11 and the content C12 into one group (FIG. 6B). In this example, the tree structure generation unit 101 determines the cluster c21 in such a manner that the cluster c21 includes all of the content C11 and the content C12, i.e., the elements of the cluster c21.

Likewise, the tree structure generation unit 101 performs processing to make a cluster c22 including a content C14 and a content C15, the distance between which is the second shortest among the distances between the contents, by making the content C14 and the content C15 into one group (FIG. 6C). In this case, the tree structure generation unit 101 also determines the cluster c22 in such a manner that the cluster c22 includes all of the content C14 and the content C15, i.e., the elements of the cluster c22.

Subsequently, the tree structure generation unit 101 respectively calculates distances between the generated two clusters c21 and c22 and the remaining content C13. In the case shown in FIG. 6C, the distance between the cluster c21 and the content C13 is shorter than the distance between the cluster c22 and the content C13. Therefore, the tree structure generation unit 101 makes a cluster c23 including the cluster c21 and the content C13 by making them into one group (FIG. 6D). In this case, the tree structure generation unit 101 also determines the cluster c23 in such a manner that the cluster c23 includes all of the cluster c21 and the content C18.

Finally, the tree structure generation unit 101 makes the remaining two clusters c22 and c23 into one group to make a cluster c24 (FIG. 6E). In this case, the tree structure generation unit 101 also determines the cluster c24 in such a manner that the cluster c24 includes all of the cluster c22 and the cluster c23. For example, the tree structure generation unit 101 can determine the cluster 24 so as to make a circle circumscribing the circles represented by the two clusters c22 and c23.

As described above, the tree structure generation unit 101 successively clusters the contents C11 to C15, thereby generating the clusters c21 to c24. Further, the tree structure generation unit 101 generates a tree structure (clustering tree diagram) based on the generated clusters c21 to c24. FIG. 7 shows the thus generated tree structure.

When the contents C11 to C15 are treated as leaf nodes, the clusters generated by the tree structure generation unit 101 form the tree structure as shown in FIG. 7. For example, there has been explained that the cluster c21 includes all of the content C11 and the content C12 in FIG. 6B. Such an inclusion relation is reflected in FIG. 7 as follows: the cluster c21 has two branches, and the content C11 and the content C12 are child nodes of the cluster c21. For example, there has been explained that the cluster c24 includes all of the cluster C22 and the cluster C23 in FIG. 6E. Such an inclusion relation is reflected the tree structure in FIG. 7 as follows: the cluster c24 has two branches, and the cluster c22 and the cluster c23 are child nodes of the cluster c24.

As is evident from FIG. 6E and FIG. 7, the finally generated cluster c24 includes all the contents (i.e., all the leaf nodes) and all the clusters (i.e., the nodes). Therefore, it is understood that the cluster c24 corresponds to a root node in the tree structure.

The generation processing of the internal tree carried out by the tree structure generation unit 101 has been hereinabove explained using the specific example.

When the tree structure generation unit 101 terminates the generation processing of the internal tree, the tree structure generation unit 101 subsequently performs a generation processing of a cluster tree as explained below.

When the generation processing of the internal tree as shown in FIG. 6A to FIG. 6E and the below-explained generation processing of the cluster tree are carried out, it is preferable to appropriately calculate central positions of clusters and distances between the clusters. The tree structure generation unit 101 according to the present embodiment may use any method in order to calculate the above information. For example, the following method may be used.

For example, when there are totally n pieces of content data, the tree structure generation unit 101 sets clusters such that each piece of data as one element belongs to one cluster, thus generating n clusters in total. It should be noted that each cluster has a central point C and a radius r as attribute values. The initial value of the central point C is a coordinate value of data. The initial value of the radius r is 0.

Subsequently, the tree structure generation unit 101 determines a cluster center C and a radius r such that a distance between the cluster center C and each of all the elements of the cluster is equal to or less than the radius r. Therefore, all the elements of the cluster are included in a sphere defined by the central point C and the radius r.

Subsequently, for example, the tree structure generation unit 101 determines the distances between the clusters as follows.

When a cluster k is generated by combining a cluster i and a cluster j, the tree structure generation unit 101 can calculate a distance d (i, j) between the cluster i and the cluster j using the following expressions 101 and 102.

d(i,j)=r(k)−r(i)−r(j)(r(k)≧r(i)+r(j)) (Expression 101)

d(i,j)=0(r(k)<r(i)+r(j)) (Expression 102)

In the above expressions 101 and 102, r(i) represents a radius of the cluster i. As is evident from the above expressions 101 and 102, the distance d between the clusters corresponds to an increment of radius when the clusters are combined.

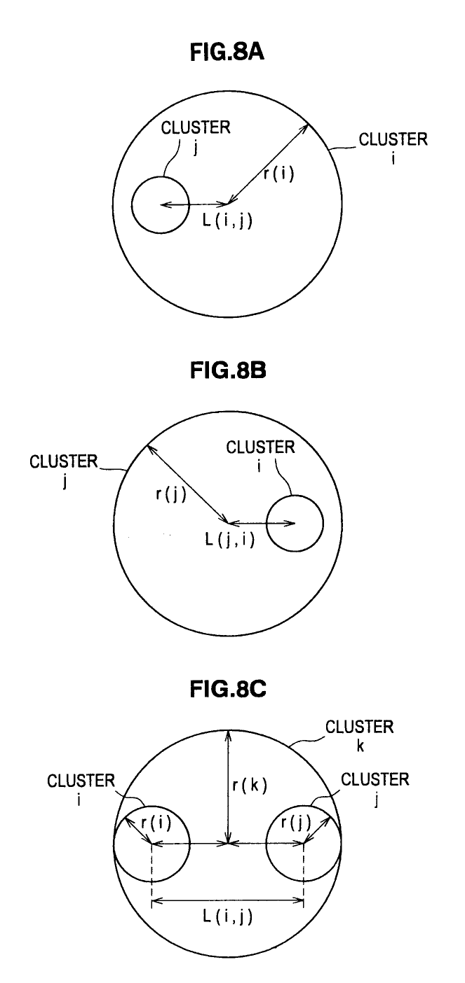

Subsequently, a method for calculating a central point and a radius of a combined cluster made by combining two clusters will be hereinafter briefly explained with reference to FIG. 8A to FIG. 8C. FIG. 8A to FIG. 8C are figures illustrating inclusion relations of elements which belong to clusters in a case where two clusters are combined.

When two clusters are combined, the tree structure generation unit 101 determines the following three patterns according to an inclusion relation of elements which belong to a cluster.

(a) m(i)⊃m(j)
(b) m(j)⊃m(i)
(c) Other than the above

It should be noted that m(i) represents a set of all elements which belong to the cluster i, and m(j) represents a set of all elements which belong to the cluster j.

The situation shown in the above (a) is a case where all the elements of the cluster j belong to the cluster i as shown in FIG. 8A. The situation shown in the above (b) is a case where all the elements of the cluster i belong to the cluster j as shown in FIG. 8B. Further, the above (c) is a situation other than the above (a) and (b). In the case of (c), for example, an inclusion relation between the cluster i and the cluster j satisfies the relationship as shown in FIG. 8C.

The tree structure generation unit 101 determines the above cases (a) to (c) based on a coordinate of each central point and each radius of the cluster i and the cluster j.

For example, when a sphere having a radius r(i) and a coordinate C(i) of a central point of the cluster i includes all of the cluster j made of a sphere having a radius r(j) and a coordinate C(j) of a central point, the tree structure generation unit 101 determines that the situation (a) as shown in FIG. 8A is satisfied.

In other words, in a case where r(i)≧r(j)+1(i,j) holds, the tree structure generation unit 101 determines that the relationship (a) is satisfied. In this example, 1(i,j) is a Euclidean distance between the central points of the cluster i and the cluster j as shown in the following expression 103.

l(i,j)=|C(i)−C(j)| (Expression 103)

In this case, where the degree of data is dim, l(i, j) can be represented by the following expression 104. In the following expression 104, c(i, k) means the k-th value of an attribute representing a center value of the cluster i.

$$\begin{matrix}[ Mathematical Expression 1 ] & \\ l ( i , j ) = \sqrt{{\sum }_{k = 1}^{dim} {( c ( i , k ) - c ( j , k ) )}^{2}} & ( Expression 104 )\end{matrix}$$

In a case where the situation (a) is satisfied, the tree structure generation unit 101 uses the central point and the radius of the cluster i as a central point and a radius of the combined cluster k.

Since the case (b) is obtained by swapping “i” and “j” of the case (a), the tree structure generation unit 101 can perform the same processing as the case (a).

When the situation (c) is satisfied, the tree structure generation unit 101 generates the cluster k as the smallest sphere including the sphere of the cluster i and the sphere of the cluster j as shown in FIG. 8C. At this example, the tree structure generation unit 101 uses the following expression 105 to calculate the radius of the cluster k. Further, the tree structure generation unit 101 uses the following expression 106 to calculate the central point of the cluster k. In this case, the central point of the cluster k is on a line connecting the central point C(i) of the cluster i and the central point C(j) of the cluster j.

$$\begin{matrix} r ( k ) = ( l ( i , j ) + r ( i ) + r ( j ) ) / 2 & ( Expression 105 ) \\ C ( k ) = \{ ( r ( i ) - r ( j ) + l ( i , j ) ) * C ( i ) + ( r ( j ) - r ( i ) + l ( i , j ) ) * C ( j ) \} / ( 2 * l ( i , j ) ) & ( Expression 106 )\end{matrix}$$

By using the above-explained method, the tree structure generation unit 101 can determine the inter-cluster distance and the central point of the cluster.

The tree structure generation unit 101 adopts the central point (central position) and the radius of the cluster thus calculated as attribute values unique to the cluster constituting cluster data. The tree structure generation unit 101 uses these attribute values unique to each cluster constituting the internal tree to execute the generation processing of the cluster tree as explained below. Further, the later-explained node extraction unit 105 can easily determine whether a certain point is included in a cluster or not by comparing attribute values of each cluster constituting the cluster tree with position information corresponding to the point in question. A certain cluster region is included in a cluster region of a parent cluster of the cluster region, and attribute values of the cluster (a central position and a radius) represent a range of elements included in the cluster. Therefore, the node extraction unit 103 and the display control unit 107, which are explained later, can easily associate elements and clusters displayed on a display screen.

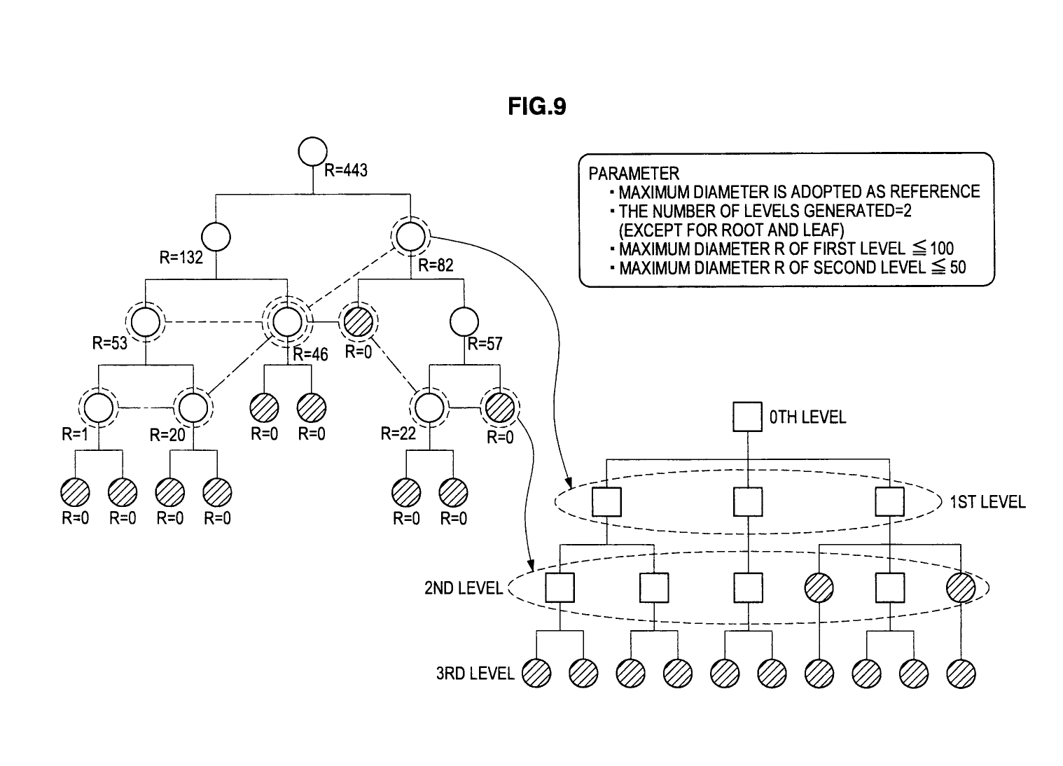

Subsequently, the generation processing of the cluster tree carried out by the tree structure generation unit 101 will be briefly explained with reference to FIG. 9. FIG. 9 is an explanatory diagram illustrating a method for generating clusters (more specifically, a method for generating a cluster tree).

The generation processing of the cluster tree based on the internal tree will be carried out with the parameters shown in FIG. 9. In FIG. 9, the following parameters are set as parameters used for the generation processing of the cluster tree. (A) What kind of feature quantity of the clusters an attention is to be paid to. (B) How many levels are generated except for the level for the root node and the level for the leaf nodes. (C) Conditions of cluster granularity in each level. More specifically, in FIG. 9, the following settings are made. (A) The maximum diameter of the clusters is adopted as a reference. (B) Two levels are generated between the level for the root node and the level for the leaf nodes. (C) The maximum diameter R of first level ≦100, and the maximum diameter R of second level ≦50 hold.

In this case, the tree structure generation unit 101 searches the tree structure of the generated internal tree, one by one in order from the root node, and identifies nodes satisfying a condition about the first node. Then, the tree structure generation unit 101 adopts the uppermost node, satisfying the condition, of each branch including an identified node as a node of the first level. As a result, in the example shown in FIG. 9, three nodes connected by a thick dotted line (a node of R=53, a node of R=46, and a node of R=82, in order from the left of the figure) are selected as nodes which belong to the first level.

Likewise, the tree structure generation unit 101 searches the tree structure of the generated internal tree, one by one in order from the root node, and identifies nodes satisfying a condition about the second node. Then, the tree structure generation unit 101 adopts the uppermost node, satisfying the condition, of each branch including an identified node as a node of the second level. As a result, in the example shown in FIG. 9, six nodes connected by an alternate long and short dashed line (a node of R=1, a node of R=20, a node of R=46, the seventh content data from the left, a node of R=22, the rightmost content data, in order from the left) are selected as nodes which belong to the second level.

By performing the above processing, the tree structure generation unit 101 generates the cluster tree as shown at the right side of FIG. 9.

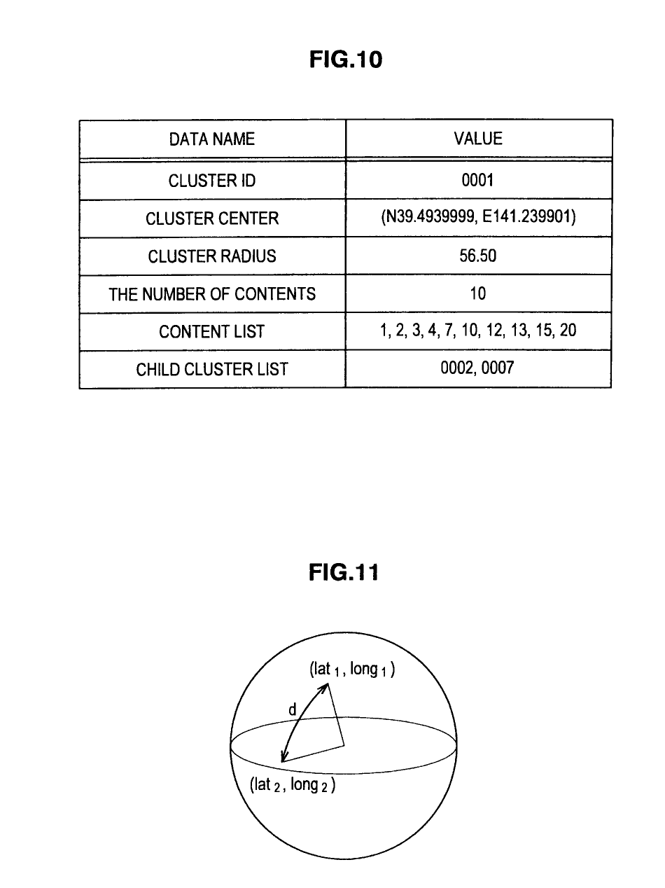

When the tree structure generation unit 101 terminates generation of the cluster tree for the contents that can be used by the information processing apparatus 10, the tree structure generation unit 101 associates metadata as shown in FIG. 10 with each generated cluster. The metadata will be hereinafter explained as cluster data.

The cluster data are information unique to each generated cluster. For example, as shown in FIG. 10, the cluster data include identification information (cluster ID) unique to a cluster, information about a cluster central position and a radius, the number of contents which belong to a cluster, a content list, a list of child clusters, and the like.

The cluster ID is identification information unique to a cluster corresponding to cluster data. For example, the cluster ID includes four-digit integer value. The cluster central position includes data representing a central position of a cluster corresponding to cluster data, and includes information for specifying a position in a feature space (for example, information representing a latitude and a longitude corresponding to the central position of the cluster). The cluster radius is data representing a radius of the cluster corresponding to cluster data. For example, a value in units of meters (m) is recorded in any format suitable for representing a feature quantity defining a feature space. The number of contents is data representing the number of contents included in a region of a cluster corresponding to cluster data. The content data list is data representing IDs of contents included in a region of a cluster corresponding to cluster data (represented as an integer value in FIG. 10). For example, a list of numerical values are recorded as IDs of contents.

When the tree structure generation unit 101 terminates clustering processing, and associates cluster data with each generated cluster, the tree structure generation unit 101 stores the tree structure data and the cluster data representing the generated tree structure in the later-explained storage unit 115 and the like.

The tree structure generation unit 101 of the information processing apparatus 10 according to the present embodiment has been explained. Subsequently, the extraction condition setting unit 103 of the information processing apparatus 10 according to the present embodiment will be explained.

The extraction condition setting unit 103 is realized with, for example, a CPU, a ROM, a RAM, and the like. The extraction condition setting unit 103 sets, based on information notified by the GPS signal processing unit 113 or the input unit 111 explained later, an extraction condition which is used when the later-explained node extraction unit 105 extracts a certain node using the tree structure generated by the tree structure generation unit 101.

More specifically, the extraction condition setting unit 103 generates, based on information notified by the GPS signal processing unit 113 or the input unit 111, information about a position used as a reference when the later-explained node extraction unit 105 performs node extraction processing, and adopts the generated position information as an extraction condition.

The position information set by the extraction condition setting unit 103 corresponds to a type of a feature space set by the tree structure generation unit 101. For example, when the feature space is defined by a feature quantity representing a position on a surface of a sphere such as latitude/longitude, the extraction condition setting unit 103 sets, as an extraction condition, position information described with a feature quantity such as latitude/longitude. Alternatively, when the feature space is a planar space defined with a two-dimensional vector, the extraction condition setting unit 103 sets, as an extraction condition, position information described with a predetermined two-dimensional vector. Alternatively, when the feature space is one-dimensional space defined with a scalar quantity such as a time, the extraction condition setting unit 103 sets, as an extraction condition, position information described with a predetermined scalar quantity

The extraction condition setting unit 103 outputs the set position information to the later-explained node extraction unit 105.

The node extraction unit 105 is realized with, for example, a CPU, a ROM, a RAM, and the like. The node extraction unit 105 uses the tree structure generated by the tree structure generation unit 101 to extract one or a plurality of nodes from among the nodes constituting the tree structure, based on the extraction condition set by the extraction condition setting unit 103.

More specifically, when the extraction condition setting unit 103 specifies any position information as an extraction condition, the node extraction unit 105 references cluster data associated with a node of the tree structure to which the specified position information belongs, and determines to which node the specified position information belongs. Further, the node extraction unit 105 extracts one or a plurality of nodes, other than the node to which the specified position information belongs, from among the nodes in the tree structure according to the position of the specified node in the tree structure.

In this case, the node extraction unit 105 extracts (i) all child nodes of the identified node and (ii) nodes, other than the identified node, branching from a parent node of the identified node (in other words, sibling nodes) from among the nodes (i.e., clusters) in the tree structure. Further, the node extraction unit 105 adopts, as a new target node, a parent node of the identified node and a sibling node of the identified node, and further extracts a node, other than the target node, branching from a parent node of the target node (i.e., sibling node of the target node). The node extraction unit 105 repeats this node extraction processing until the target node corresponds to the root node.

In some tree structure generated by the tree structure generation unit 101, position information set by the extraction condition setting unit 103 may belong to a plurality of nodes in the tree structure (in other words, the position information belongs to a plurality of clusters). In this case, the node extraction unit 105 preferably adopts, as a node to which the specified position information belongs, a node located at the deepest position from the root node from among the plurality of nodes to which the set position information belongs.

In the explanation below, the node extraction processing carried out by the above-explained node extraction unit 105 will be explained in a more specific manner with reference to FIG. 11 to FIG. 17.

In the explanation below, it is assumed that the feature space is a positional space on a surface of a sphere representing a position on the surface of the earth, and any position in a feature space is defined by a latitude and a longitude. It is assumed that a distance between data in the feature space is defined by a so-called ground distance as shown in FIG. 11.

A ground distance represents a distance between two locations on a sphere, and corresponds to a length of a curve d shown in FIG. 11. In a case where coordinates of two locations on a spherical surface are respectively represented as (lat₁, long₁), (lat₂, long₂), this ground distance d is a value calculated from the following expression 107.

[Numerical Expression 2]

d=cos⁻¹{sin(lat₁)sin(lat₂)+cos(lat₁)cos(lat₂)cos(long₂−long₁)} (Expression 107)

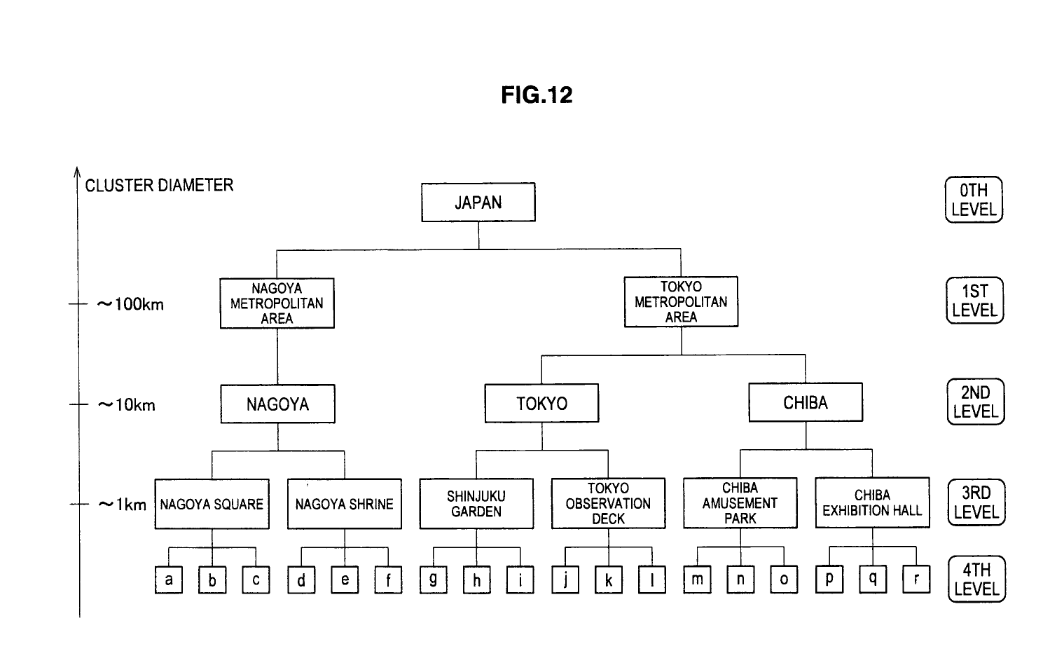

FIG. 12 shows an example of a tree structure (cluster tree) obtained as a result of clustering of an image content including information about latitude/longitude as metadata in the feature space as described above. The tree structure shown in FIG. 12 is generated by the tree structure generation unit 101, and this tree structure represents a result obtained by performing clustering operation with attention paid to locations where image contents are taken.

In FIG. 12, nodes a to r, i.e., leaf nodes, correspond to content data of respective image contents, and are located in the fourth level in the tree structure. Further, nodes located from the 3rd level to the 0th level respectively correspond to clusters in the cluster tree generated as a result of clustering performed by the tree structure generation unit 101.

As explained in FIG. 6A to FIG. 9, the clustering performed by the tree structure generation unit 101 forms a group including those whose inter-data distances (or inter-cluster distances) are close. Therefore, a region represented by each cluster becomes larger as it moves from the 4th level to the 0th level as shown in the left side of FIG. 12 using the diameter of clusters. In the tree structure shown in FIG. 12, the maximum size (the maximum diameter of clusters in FIG. 12) is determined in each level as illustrated in FIG. 9, and granularities of nodes (granularities of clusters) are arranged for each level.

In this example, names given to clusters located from the 0th level to the 3rd level are prepared only for the purpose of explanation, and clusters generated by the tree structure generation unit 101 may not be given names characterizing regions in a real space represented by the clusters. When there arises a situation where clusters are presented to users, the tree structure generation unit 101 references information representing addresses described in metadata of contents and various kinds of information input by users, and may give specific names to the clusters.

In this example, attention is paid to leaf nodes “j”, “k”, “l” located in the 4th level as shown in FIG. 12. In the content data corresponding to these leaf nodes, information about locations described in metadata are locations closely arranged with each other, and the content data are data whose distances are close in the feature space. Accordingly, these three pieces of data are put into one group, and are included in a node (cluster) called “Tokyo Observation Deck”. The reason why a landmark “Tokyo Observation Deck” is given to this node is that information about locations associated with the leaf nodes j to l are information representing a location around the location “Tokyo Observation Deck”.

In FIG. 12, a node having a name “Shinjuku Garden” is a node including the leaf node g to the leaf node i including position information representing a location around the landmark “Shinjuku Garden”. This node “Shinjuku Garden” and the node “Tokyo Observation Deck” are located close to each other, and therefore, both of the node “Shinjuku Garden” and the node “Tokyo Observation Deck” are included in a node “Tokyo”.

Cluster regions of nodes in parent-child relationship are overlapped. For example, the node “Tokyo Observation Deck” is included in the node “Tokyo”. In contrast, cluster regions of nodes other than the above are not overlapped. For example, cluster regions of nodes “Tokyo” and “Nagoya” are not overlapped. In other words, this tree structure is a tree structure having all the five features (1) to (5) of the tree structure as described above.

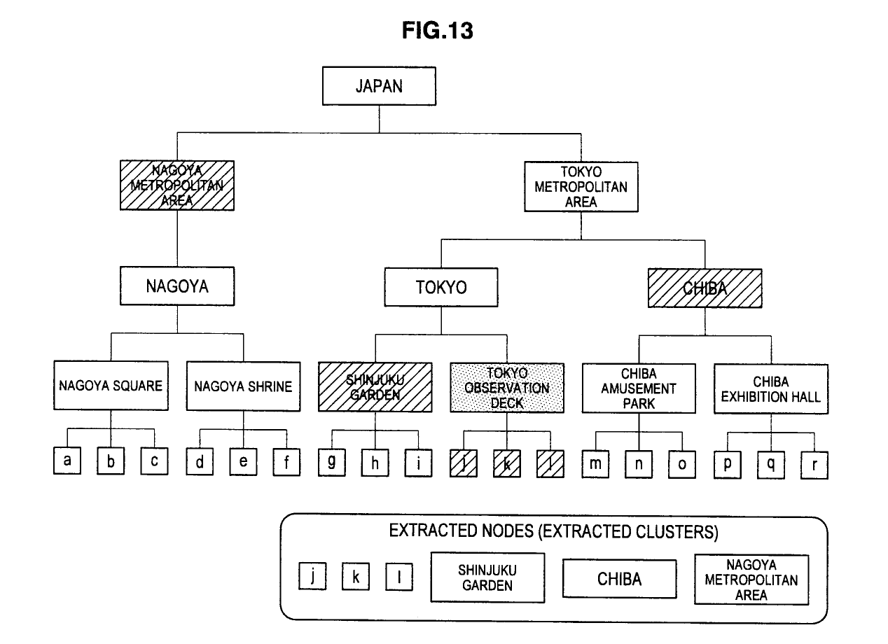

Processing performed by the node extraction unit 105 will be explained in a more specific manner with reference to FIG. 13 to FIG. 15 in a case where the extraction condition setting unit 103 sets certain position information as an extraction condition when the tree structure as shown in FIG. 12 is generated by the tree structure generation unit 101.

FIG. 13 shows an arrangement of nodes in a tree structure, which are extracted when the extraction condition setting unit 103 notifies position information located in a region of the node “Tokyo Observation Deck”.

In such case, first, the node extraction unit 105 requests the tree structure generation unit 101 to notify whether there is any tree structure currently generated, and obtains tree structure data about the tree structure (cluster tree) as shown in FIG. 13 from the tree structure generation unit 101. Subsequently, the node extraction unit 105 checks nodes one by one in order from the 0th level to determine which node includes the notified position information. This determination processing is performed by comparing the notified position information with a cluster region defined by a cluster central position and a cluster radius described in cluster data corresponding to each node.

In the example shown in FIG. 13, the node extraction unit 105 searches for nodes to which the notified position information belongs, and finds out that the notified position information belongs to four nodes, i.e., “Japan” node, “Tokyo Metropolitan Area” node, “Tokyo” node, and “Tokyo Observation Deck” node, in order from the 0th level.

Subsequently, the node extraction unit 105 selects a node located in the lowermost level from among the nodes to which the notified position information belongs. In the example shown in FIG. 13, the node extraction unit 105 selects the node called “Tokyo Observation Deck”, and adopts the node “Tokyo Observation Deck” as a start node of the node extraction processing.

Subsequently, the node extraction unit 105 extracts the leaf node j, the leaf node k, and the leaf node l, i.e., all child nodes of the start node “Tokyo Observation Deck”. Further, the node extraction unit 105 extracts the node “Shinjuku Garden” which is a sibling node of the start node “Tokyo Observation Deck”.

Subsequently, the node extraction unit 105 adopts, as a target node, the node “Tokyo”, i.e., a parent node of the node “Tokyo Observation Deck” and the node “Shinjuku Garden”, and extracts the node “Chiba”, i.e., a sibling node of the target node “Tokyo”.

Subsequently, the node extraction unit 105 adopts, as a new target node, the node “Tokyo Metropolitan Area”, i.e., a parent node of the extracted node “Chiba” and the target node “Tokyo”, and the node “Nagoya Metropolitan Area”, i.e., a sibling node of the target node “Tokyo Metropolitan Area”.

Subsequently, the node extraction unit 105 adopts, as a new target node, the node “Japan”, i.e., a parent node of the extracted node “Nagoya Metropolitan Area” and the target node “Tokyo Metropolitan Area”. In this example, in the tree structure shown in FIG. 13, the node “Japan” is the root node. Therefore, the node extraction unit 105 terminates the node extraction processing.

As a result of the extraction processing as described above, the node extraction unit 105 extracts the leaf nodes j to l, the node “Shinjuku Garden”, the node “Chiba”, and the node “Nagoya Metropolitan Area” from among the nodes in the tree structure as a result of clustering based on a specified position.

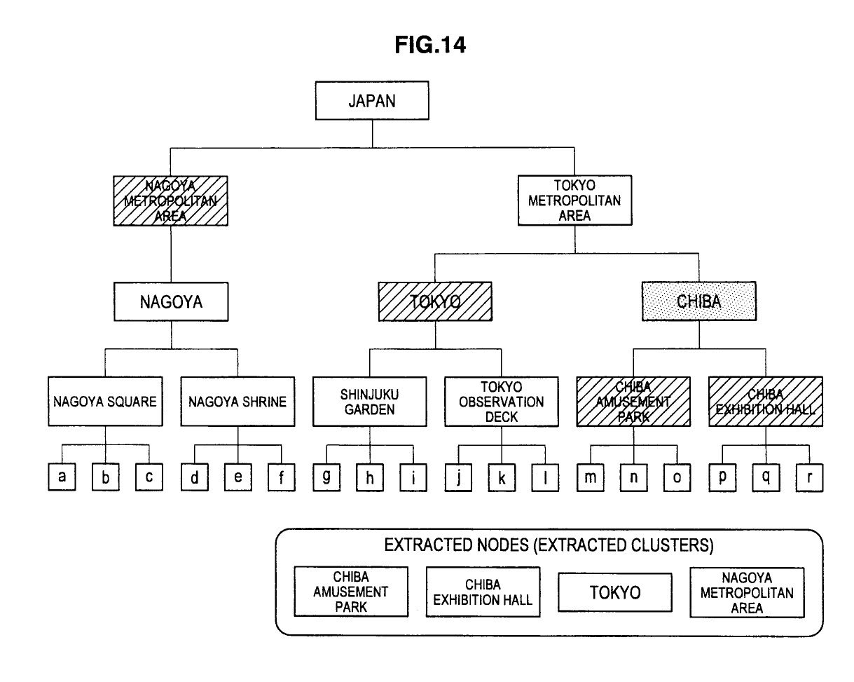

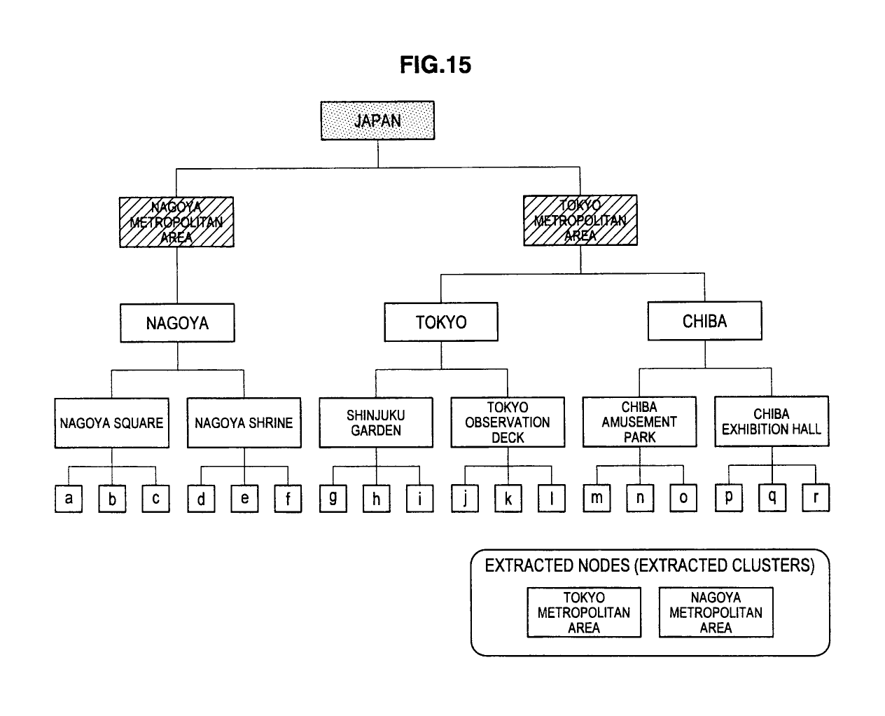

FIG. 14 illustrates an arrangement of a node in the tree structure, wherein the node is extracted when the extraction condition setting unit 103 notifies position information located within the region of the node “Chiba” but not included in any of regions of child nodes of the node “Chiba”.

In the example shown in FIG. 14, the node extraction unit 105 selects a node to which the position information, i.e., the notified extraction condition, belongs, in the same manner as the example shown in FIG. 13. In this example, the node extraction unit 105 selects the node “Chiba” as the start node of the node extraction processing.

Subsequently, the node extraction unit 105 extracts a node “Chiba Amusement Park” and a node “Chiba Exhibition Hall”, i.e., child nodes of the node “Chiba”. Further, the node extraction unit 105 extracts the node “Tokyo”, i.e., a sibling node of the start node “Chiba”.

Subsequently, the node extraction unit 105 adopts, as a target node, the node “Tokyo Metropolitan Area”, i.e., a parent node of the node “Tokyo” and the node “Chiba”, and extracts the node “Nagoya Metropolitan Area”, i.e., a sibling node of the target node “Tokyo Metropolitan Area”.

Subsequently, the node extraction unit 105 adopts, as a new target node, the node “Japan”, i.e., a parent node of the extracted “Nagoya Metropolitan Area” and the target node “Tokyo Metropolitan Area”. In this example, in the tree structure shown in FIG. 14, the node “Japan” is the root node. Therefore, the node extraction unit 105 terminates the node extraction processing.

As a result of the extraction processing as described above, the node extraction unit 105 extracts the node “Chiba Amusement Park”, the node “Chiba Exhibition Hall”, the node “Tokyo”, and the node “Nagoya Metropolitan Area” from among the nodes in the tree structure as a result of clustering based on a specified position.

FIG. 15 illustrates an arrangement of a node in the tree structure, wherein the node is extracted when the extraction condition setting unit 103 notifies position information located within the region of the node “Japan” but not included in any of regions of child nodes of the node “Japan”.

In the example shown in FIG. 15, the node extraction unit 105 selects a node to which the position information, i.e., the notified extraction condition, belongs, in the same manner as the example shown in FIG. 13. In this example, the node extraction unit 105 selects the node “Japan” as the start node of the node extraction processing.

When the start node of the node extraction processing is the root node in the tree structure, the node extraction unit 105 extracts all the child nodes of the root node (in other words, all the nodes of the 1st level), and terminates the node extraction processing. Therefore, in the example shown in FIG. 15, when the node extraction unit 105 recognizes that the start node is the root node, the node extraction unit 105 extracts the node “Tokyo Metropolitan Area” and the node “Nagoya Metropolitan Area”, i.e., child nodes of the root node, and terminates the node extraction processing.

In some cases, position information notified from the extraction condition setting unit 103 is not included in the root node of the tree structure obtained from the tree structure generation unit 101. In such case, the node extraction unit 105 extracts the root node of a tree structure, and terminates the processing. For example, in the tree structure shown in FIG. 12, when the extraction condition setting unit 103 notifies position information not included in the root node “Japan”, the node extraction unit 105 extracts the root node “Japan”, and terminates the processing.

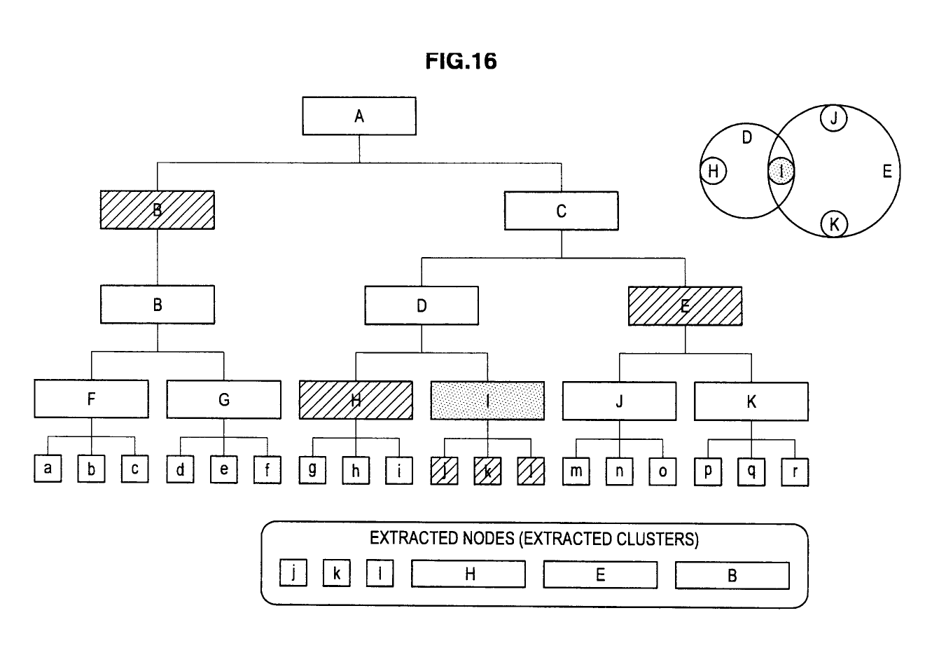

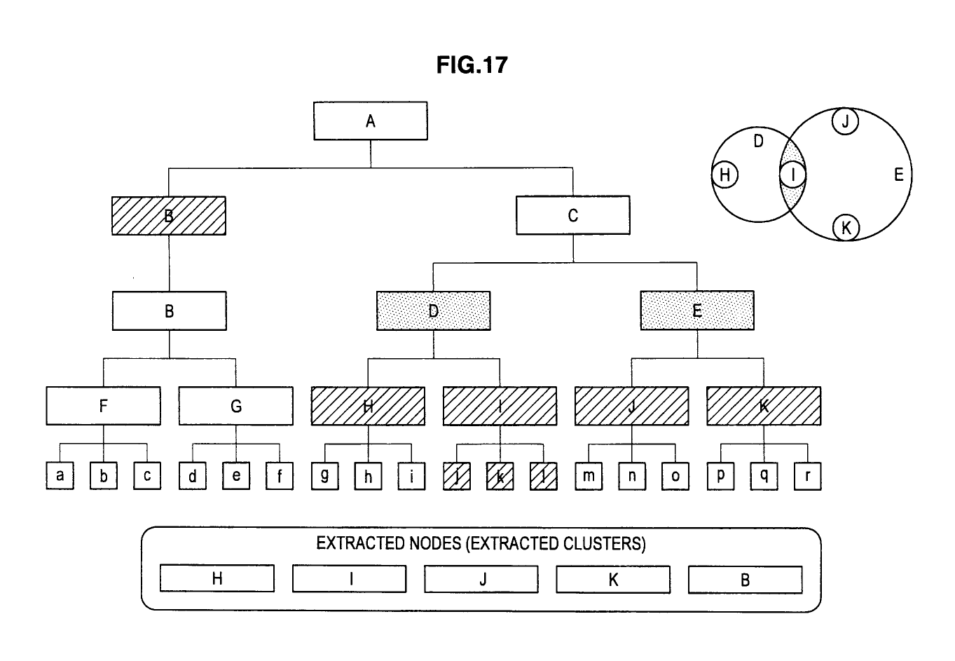

Subsequently, node extraction processing will be explained with reference to FIG. 16 and FIG. 17 in a case of a tree structure in which there is an overlapping region of nodes without parent-child relationship (in other words, a tree structure that does not have the feature (5) of the five features of the tree structure as explained above).

In the tree structure shown in FIG. 16 and FIG. 17, a node I belongs to both regions of two nodes (a node D and a node E) as shown in a Venn diagram in the upper right portion of each figure.

FIG. 16 illustrates an arrangement of nodes in a tree structure, wherein the nodes are extracted when the extraction condition setting unit 103 notifies position information which belongs to the region of the node I in such case.

The node extraction unit 105 references the tree structure obtained from the tree structure generation unit 101 to recognize that there is an overlapping region of nodes without parent-child relationship. Then, the node extraction unit 105 performs the processing explained below.

First, for each branch branched from the root node, the node extraction unit 105 determines which node includes the notified position information. In the example shown in FIG. 16, the node extraction unit 105 recognizes that the notified position information is included in the node I which belongs to a flow branched from the node C and the node E which belongs to a flow branched from the node C.

When a plurality of nodes including the specified position information are identified, the node extraction unit 105 subsequently determines which of the plurality of nodes is located in the lowermost level, and selects the node located in the lowermost level as a start node of node extraction processing. In the example shown in FIG. 16, the node E belongs to the 2nd level, and the node I belongs to the 3rd level. Therefore, the node extraction unit 105 selects the node I in the 3rd level as the start node of the node extraction processing. At this point, there is only one selected node, and therefore, the same processing as the case illustrated in FIG. 13 will be performed in the following processing. As a result, as shown in FIG. 16, the node extraction unit 105 extracts the leaf nodes j to l, the node H, the node E, and the node B as a result of clustering based on the specified position.

On the other hand, the example shown in FIG. 17 shows nodes extracted by the node extraction unit 103 when the position information notified by the extraction condition setting unit 103 is included in both of the node D and the node E as shown in the Venn diagram in the figure.

When a plurality of nodes including the specified position information are identified, the node extraction unit 105 recognizes that the node D and the node E are candidates for the start node. Subsequently, the node extraction unit 105 determines which node is located in a lower level based on the tree structure obtained from the tree structure generation unit 101. In the present example, the node extraction unit 105 recognizes that both of the two nodes belong to the same level. When the plurality of nodes serving as candidates for the start node belong to the same level as described above, the node extraction unit 105 treats each of the plurality of nodes in the same level as the start node. In the present example, the node extraction unit 105 selects the node D and the node E as the start nodes of the node extraction processing.

Subsequently, the node extraction unit 105 extracts all child nodes of the start node. In the example shown in FIG. 17, the node extraction unit 105 extracts the node H to the node K, i.e., child nodes of the node D and the node E, respectively. Subsequently, the node extraction unit 105 extracts all sibling nodes of the start node. However, in the example shown in FIG. 17, there is no child node of the node C other than the node D and the node E, i.e., the start nodes (in other words, there is no sibling node other than the node D and the node E). Therefore, the node extraction unit 105 selects nothing.

Subsequently, the node extraction unit 105 adopts as a target node, a parent node of each start node, and continues node extraction. In the present example, both of the parent node of the start node D and the parent node of the node E are the node C. Therefore, the node extraction unit 105 makes these two selection states into one to adopt only the node C as a target node, and continues the processing.

The node extraction unit 105 repeats the processing until the target node no longer has any parent node. As a result, in the example shown in FIG. 17, the node extraction unit 105 extracts the node H, the node I, the node J, the node K, and the node B as a result of clustering based on the specified position.

Since there is only one root node in the tree structure, a plurality of selection states are ultimately combined into one in the root node.

In the above example, the processing performed by the node extraction unit 105 in a case where the extraction condition setting unit 103 specifies a point in a feature space has been described. In the explanation below, processing will be explained, where not only a position but also a region having a range in a feature space is specified.

This processing can be performed, for example, in a case where clustering is performed relying on a current view (displayable region) when a clustering result is displayed somewhere. For example, a map with a scale displaying the entire Japan is displayed on a display screen of the display unit 109 of the information processing apparatus 10. In this example, the extraction condition setting unit 103 notifies, as an extraction condition, a region represented by a circle having a center at a certain point.

In this example, when position information notified by the extraction condition setting unit 103 is a location around the landmark “Tokyo Observation Deck” shown in FIG. 12, the extraction condition setting unit 103 extracts the leaf nodes j, k, l, if the above method is used. Assume that information corresponding to such granularity (for example, a thumbnail image of an image content) is displayed on a display screen. In this case, the size of the location around “Tokyo Observation Deck” is estimated to be very small in the map showing the entire Japan, information corresponding to these nodes is considered to be overlapping with each other. Therefore, in such situation, the user's viewability can be improved by displaying the extraction result on the display screen with a node granularity such as “Tokyo Observation Deck” and “Tokyo” which is higher than the granularity of the selected node, and this is said to be appropriate.

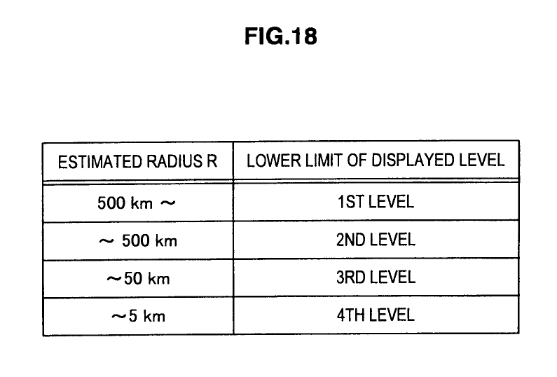

Accordingly, in order to cope with such case, the node extraction unit 105 previously stores, in the later-explained storage unit 115 and the like, a correspondence between a lower limit corresponding to a level in a tree structure as shown in FIG. 18 and a radius of a specified region.

In the example shown in FIG. 18, in a case where, for example, a region notified by the extraction condition setting unit 103 is a circle having a center at a certain point and a radius of 20 km, the node extraction unit 105 references a table (or a database) as shown in FIG. 18 to check the lower limit of the displayed level, and recognizes that the lower limit of the level is the 3rd level. In this case, in the processing explained in FIG. 13 to FIG. 15, the node extraction unit 105 can determine an extraction node while recognizing that the end of the given tree structure is the 3rd level (in other words, there is no child node in levels deeper than the 3rd level).

For example, the following case is considered: the nodes “j”, “k”, “l” can be extracted when only a position is specified as a condition setting. In such case, when the lower limit of the level is three, the node extraction unit 105 extracts the node “Tokyo Observation Deck” instead of these three nodes.

In the above explanation, the specified region is the circle having the center at the certain point. Alternatively, this specified region may be a rectangular region represented as an oblong. In this case, half of a shorter side of the oblong or half of an average of a shorter side and a longer side may be used in place of the above-explained specified radius.

Alternatively, instead of a circular shape and a rectangular shape, any shape may be specified as a region. In this case, a square root of an area of a region (in a case of n-th degree, (1/n)th power of a volume) may be used in place of the above-explained specified radius.

In the above example, the lower limit of the displayed level is determined according to the size of the specified region. Alternatively, the upper limit of a displayed level may be determined according to the size of the specified region.

The node extraction unit 105 may automatically generate correspondence according a data structure, instead of previously generating a correspondence table as shown in FIG. 18. For example, first, the maximum size in each level is checked, and this size may be processed by a previously-defined function (for example, a multiple of the maximums size), whereby a specified radius corresponding to the lower limit of the thus obtained level may be calculated in an opposite manner.

Even in a case where a position on the surface of the earth is represented as in the above example, the surface of the sphere can be approximated as a flat surface when data exist locally. Therefore, a two-dimensional feature plane having a latitude x and a longitude y may be considered, and a data structure (tree structure) generated by approximating a distance with a Euclidean distance may be used. Even in such case, the same results can be obtained by performing the same method as the above-explained method.

Further, the feature space may be one-dimensional time space. In such case, a position in a feature space is defined by a time, i.e., scalar quantity, and a distance between data in the feature space is defined by a time difference. By performing the above-explained processing on the feature space, grouping based on a particular time can be achieved.

For example, a case where a current time is specified as a particular time will be considered. In this case, data represent times when pictures were taken. In this case, pictures taken more recently are clustered with finer granularities, and older pictures taken in the past are clustered with coarser granularities. Therefore, the following effects can be obtained. For example, recent pictures are clustered with a granularity in units of days, and on the other hand, pictures taken several months ago are clustered with a granularity in units of months. Further, pictures taken several years ago are clustered in units of years.

As explained above, the node extraction unit 105 according to the present embodiment does not perform clustering upon structuring a tree structure every time position information is specified. Instead, the node extraction unit 105 uses a tree structure (cluster tree) previously structured based on distances between data in a feature space to extract nodes while determining which node of the tree structure the specified position information belongs to. Therefore, even when the specified position information changes from time to time, it is not necessary to re-execute clustering on every such occasion. Clustering can be performed to change a cluster granularity based on a distance from a particular position in a feature space, while a load necessary for clustering is suppressed.

The functions of the node extraction unit 105 according to the present embodiment have been hereinabove explained in detail.

Subsequently, the display control unit 107 according to the present embodiment will be explained with reference back to FIG. 3.

The display control unit 107 is realized with, for example, a CPU, a ROM, a RAM, and the like. When the display control unit 107 receives from the later-explained input unit 111 a notification indicating that user operation for instructing viewing of clusters has been made, the display control unit 107 obtains contents stored in the later-explained storage unit 115 and the like, based on nodes extracted by the node extraction unit 105 (in other words, clusters). Thereafter, the display control unit 107 structures a view by grouping the obtained image contents based on extracted clusters, and performs display control so that the later-explained display unit 109 displays this view.

As necessary, the display control unit 107 may request the tree structure generation unit 101 or the node extraction unit 105 to transmit the tree structure data. As necessary, the display control unit 107 may request the tree structure generation unit 101 or the node extraction unit 105 to give the tree structure or a parent node, child nodes, sibling nodes of a certain node, and the like.

A display control method of the display unit 109 carried out by the display control unit 107 will be explained in detail later.

The display unit 109 is an example of a display device of the information processing apparatus 10 according to the present embodiment. The display unit 109 is a display unit for displaying an execution screen and the like of various applications and various contents that can be executed by the information processing apparatus 10. Further, the display unit 109 may display various objects used for operating execution situations of various applications, operations of various contents, and the like.

Various kinds of information are displayed in the display screen of the display unit 109 under the control of the display control unit 107. An example of a display screen displayed on the display unit 109 will be hereinafter explained in detail again.

The input unit 111 is an example of an input device of the information processing apparatus 10 according to the present embodiment. This input unit 111 is realized with, for example, a CPU, a ROM, a RAM, an input device, and the like. The input unit 111 converts user operation performed on a keyboard, a mouse, a touch panel, and the like of the information processing apparatus 10 into an electric signal corresponding to the user operation, and notifies the user operation to the extraction condition setting unit 103 and the display control unit 107. For example, when a user performs operation for specifying a location of the display screen or operation for specifying a region having a center at a certain location of the display screen, the input unit 111 generates information representing the location or the region, and outputs the information to the extraction condition setting unit 103 and the like.

The GPS signal processing unit 113 is realized with, for example, a CPU, a ROM, a RAM, a communication device, and the like. The GPS signal processing unit 113 calculates position information of a location where the information processing apparatus 10 is located (more specifically, a location where a GPS signal is receive) based on a GPS signal received by a GPS receiver antenna (not shown). The GPS signal processing unit 113 outputs calculated position information to the extraction condition setting unit 103. This calculated position information includes various kinds of metadata such as a latitude, a longitude, and an altitude.

The storage unit 115 is an example of a storage device of the information processing apparatus 10 according to the present embodiment. This storage unit 115 may store various content data of the information processing apparatus 10, metadata associated with the content data, and the like. Further, the storage unit 115 may store tree structure data corresponding to a tree structure generated by the tree structure generation unit 101. Further, the storage unit 115 may store execution data corresponding to various applications which are used by the display control unit 107 to display various kinds of information on the display unit 109. Further, this storage unit 115 may store various parameters or progress of processing that are necessary to be stored while the information processing apparatus 10 performs certain processing, and may store various kinds of databases and the like as necessary. This storage unit 115 can be freely read and written by each processing unit of the information processing apparatus 10 according to the present embodiment.

It should be noted that the information processing apparatus 10 according to the present embodiment may be any apparatus as long as it has a function of obtaining position information and a generation time of a content from the content and an attached data file. Examples of applicable apparatuses include imaging apparatuses such as a digital still camera and a digital video camera, a multimedia content viewer with a built-in storage device, a personal digital assistant capable of recording, storing, and viewing a content, a content management viewing service working in synchronization with an online map service, application software for a personal computer, a portable game terminal having a picture data management function, a mobile phone with a camera having a storage device, and a digital household electrical appliance and a game device having a storage device and a picture data management function. The effect of grouping can be obtained more significantly when the capacity of a storage device is large. However, regardless of the storage capacity, the function according to the present embodiment can be applied.

An example of functions of the information processing apparatus 10 according to the present embodiment has been hereinabove explained. Each of the above constituent elements may be made with a generally-used member and circuit, or may be made with hardware dedicated for the function of each constituent element. Alternatively, all of the functions of the constituent elements may be performed by a CPU and the like. Therefore, the used configuration may be changed as necessary in accordance with the state of the art at the time when the present embodiment is carried out.

It is possible to create a computer program for realizing the functions of the above-described information processing apparatus according to the present embodiment, and the computer program can be implemented on a personal computer and the like. Further, a computer-readable recording medium storing such computer program can be provided. Examples of recording media include a magnetic disk, an optical disk, a magneto-optical disk, and a flash memory. Further, for example, the above computer program may be distributed through a network, without using any recording medium.

In the above explanation, each node of the tree structure is a hypersphere. However, it is to be understood that each node of the tree structure is not limited to the above example. A node region of the tree structure may be represented using, for example, a method for representing a node region with an oblong (R-Tree method), a method for representing a node region with a combination of an oblong and a circle (SR-Tree method), and a method for representing a node region with a polygon.

### <Node Extraction Method>

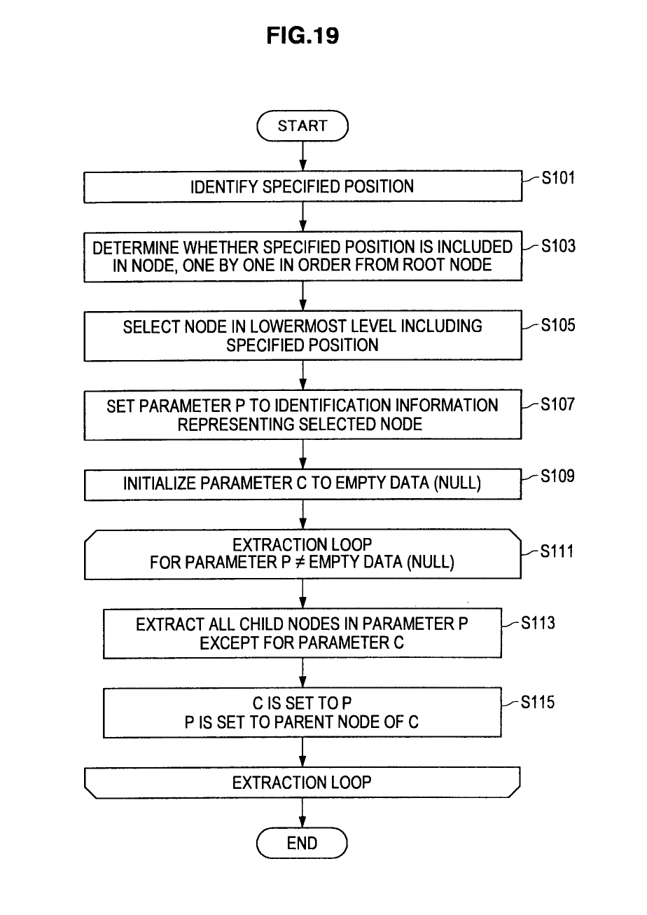

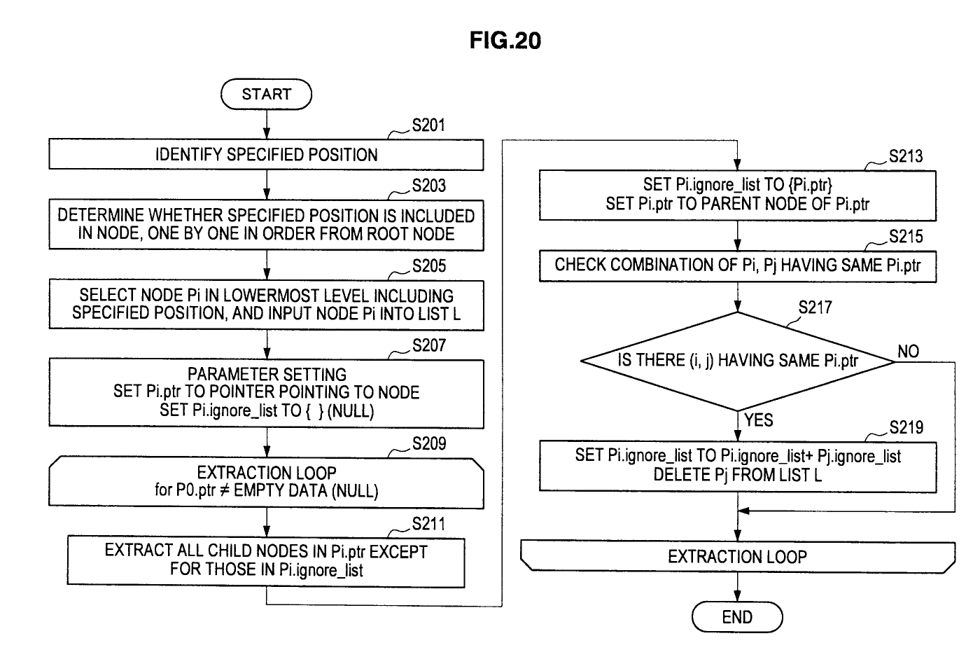

Subsequently, an information processing method carried out by the information processing apparatus 10 according to the present embodiment (more specifically, node extraction method) will be briefly explained with reference to FIG. 19 and FIG. 20. FIG. 19 and FIG. 20 are flow diagrams for illustrating a node extraction method carried out by the information processing apparatus 10 according to the present embodiment.

It is assumed that that, before the following explanation, the tree structure generation unit 101 has generated the above-explained tree structure (cluster tree) about the content data that can be used by the information processing apparatus 10, and the node extraction unit 105 has obtained tree structure data corresponding to the tree structure from the tree structure generation unit 101.

First, a node extraction method using a tree structure in which there is an overlapping region only in nodes in parent-child relationship (in other words, tree structure having all of the above-explained five features (1) to (5) of the tree structure) will be briefly explained with reference to FIG. 19.

First, when the node extraction unit 105 receives from the extraction condition setting unit 103 position information about a position serving as a reference for node extraction processing, the node extraction unit 105 identifies which position in a feature space related to a tree structure the specified position information corresponds to (step S101). Subsequently, the node extraction unit 105 compares a region in the feature space occupied by a node in the tree structure with a position in the feature space of the specified position information, thereby determining whether the specified position is included in a node, one by one in order from the root node (step S103). Subsequently, the node extraction unit 105 selects, as a start node of node extraction processing, a node in the lowermost level including the specified position specified by the extraction condition setting unit 103 (step S105).

Subsequently, the node extraction unit 105 sets a parameter P to identification information representing the selected node (step S107). Subsequently, the node extraction unit 105 initializes a parameter C, representing nodes having been subjected to extraction processing, to empty data (null) (step S109).

Thereafter, the node extraction unit 105 repeats step S113 and step S115 explained below while the parameter P is not empty data (step S111).

In step S113, the node extraction unit 105 extracts all child nodes of the node represented in the parameter P except for those described in the parameter C while referencing the tree structure data obtained from the tree structure generation unit 101.

In step S115, the parameters are updated. In other words, the node extraction unit 105 sets the parameter C to the content currently described in the parameter P. Further, the node extraction unit 105 sets the parameter P to a parent node of the node represented in the newly set parameter C.

The node extraction unit 105 can execute the node extraction processing as illustrated in FIG. 12 to FIG. 15 by repeating step S113 and step S115 while the condition shown in step S111 is satisfied.

Subsequently, a node extraction method using a tree structure in which there is an overlapping region in nodes other than nodes in parent-child relationship (in other words, one without the feature (5) of the above-explained five features of the tree structure) will be briefly explained with reference to FIG. 20.

First, when the node extraction unit 105 receives from the extraction condition setting unit 103 position information about a position serving as a reference for node extraction processing, the node extraction unit 105 identifies which position in a feature space related to a tree structure the specified position information corresponds to (step S201). Subsequently, the node extraction unit 105 compares a region in the feature space occupied by a node in the tree structure with a position in the feature space of the specified position information, thereby determining whether the specified position is included in a node, one by one in order from the root node (step S203). Subsequently, the node extraction unit 105 selects, as a start node of node extraction processing, a node Pi in the lowermost level including the specified position specified by the extraction condition setting unit 103, and inputs the node Pi into a list L (step S205).

Subsequently, the node extraction unit 105 sets various parameters. In other words, the node extraction unit 105 sets a parameter Pi.ptr to a pointer pointing to the selected node, and sets a parameter Pi.ignore_list to empty data (step S207).

Subsequently, the node extraction unit 105 repeats step S211 to step 219 explained below while the parameter P0.ptr is not empty data (step S209).

In step S211, the node extraction unit 105 extracts all child nodes of the node represented in the parameter Pi.ptr except for those described in the parameter Pi.ignore_list while referencing the tree structure data obtained from the tree structure generation unit 101.

In step S213, the parameters are updated. In other words, the node extraction unit 105 inputs the pointer currently described in the parameter Pi.ptr to the parameter Pi.ignore_list. Further, the node extraction unit 105 sets the parameter Pi.ptr to a parent node of the node represented in Pi.ptr.

In step S215, the node extraction unit 105 determines whether there is a combination of nodes Pi, Pj having the same Pi.ptr. When it is determined that there is a combination of (i, j) having the same Pi.ptr in the determination step in step S217, the node extraction unit 105 executes the following processing. In other words, the node extraction unit 105 combines Pi.ignore_list and Pj.ignore_list to make a new Pi.ignore_list, and delete Pj from the list L (step S219). On the other hand, when it is determined that there is no combination of (i, j) having the same Pi.ptr, the node extraction unit 105 does not execute the processing in step S219.

The node extraction unit 105 can execute the node extraction processing as illustrated in FIG. 16 to FIG. 17 by repeating step S211 to step S219 while the condition shown in step S209 is satisfied.

Since the node extraction method shown in FIG. 20 is obtained by generalizing the node extraction method shown in FIG. 19, the case shown in FIG. 12 to FIG. 15 can be handled by the method shown in FIG. 20. However, when it is not necessary to generalize the processing, it is preferable to use the method shown in FIG. 19 using simpler processing.

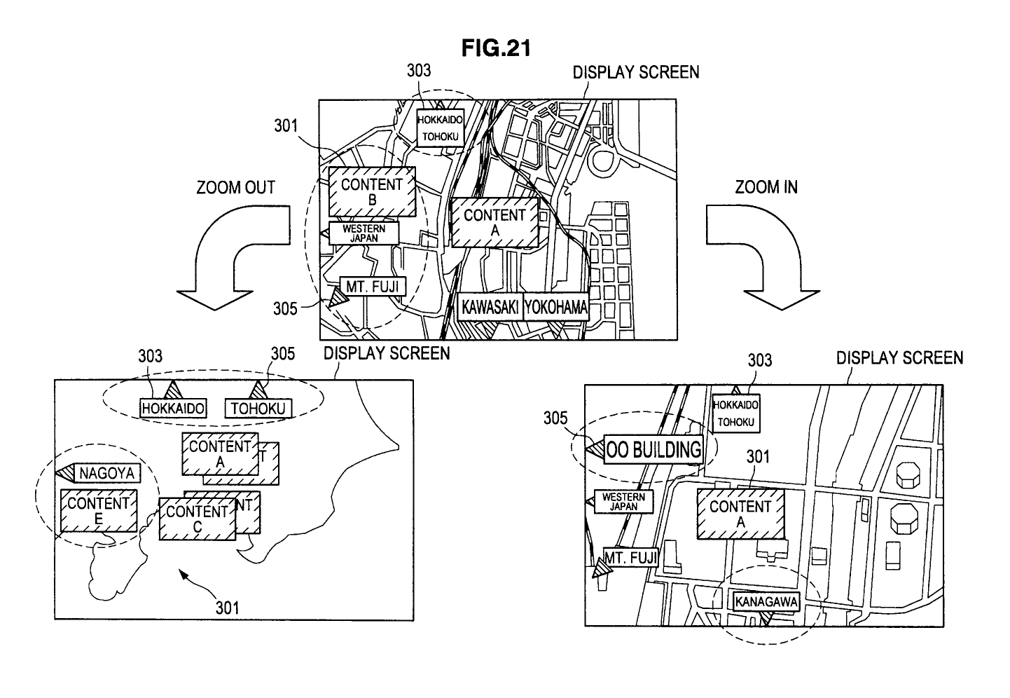

The node extraction method carried out by the information processing apparatus 10 according to the present embodiment has been hereinabove explained briefly. Subsequently, an example of a display screen of the display unit 109 and a display control method carried out by the display control unit 107 according to the present embodiment will be explained in detail with reference to FIG. 21 to FIG. 26.

### <Example of Display Screen>

First, an example of a display screen displayed on the display unit 109 controlled by the display control unit 107 according to the present embodiment will be explained in detail with reference to FIG. 21 to FIG. 25.

In the explanation below, the display control unit 107 executes an application for displaying objects such as thumbnails and icons corresponding to content data on a display position corresponding to position information associated with the content data. In an application explained below, objects corresponding to image contents such as still picture contents and motion picture contents are displayed using a map application for displaying a map around a specified position.

It is assumed that, before the following explanation, a tree structure (cluster tree) about contents that can be executed by the information processing apparatus 10 has been structured in advance.

When a user operates this map application to start the map application, and an operation signal corresponding to this user's operation is notified from the input unit 111 to the display control unit 107, the display control unit 107 obtains a corresponding program main body of the map application from the storage unit 115 and the like and executes the program main body. Accordingly, a map around a predetermined position is displayed in the display screen of the display unit 109. In this example, the position initially displayed in the display screen may be a current position notified by the GPS signal processing unit 113 or may be a position specified by a user and notified by the input unit 111.

In this example, when the display control unit 107 generates an execution screen by executing this map application, the display control unit 107 performs adjustment so that the position specified by the input unit 111 or the GPS signal processing unit 113 is positioned in the center of the execution screen.

On the other hand, information about the position specified by the input unit 111 or the GPS signal processing unit 113 is also notified to the node extraction unit 105 via the extraction condition setting unit 103. The node extraction unit 105 extracts one or a plurality of nodes from among nodes (clusters) included in the previously structured tree structure by performing the processing as explained above, and outputs the nodes to the display control unit 107.

In this example, when the display control unit 107 displays, on the execution screen, a list of contents that can be used by the information processing apparatus 10, the display control unit 107 changes an object of a content displayed in the display screen according to a distance between the center position of the execution screen and a position represented by position information corresponding to the content.

More specifically, when a content is included in a region displayed in the display screen as the execution screen (when the position information of the content indicates a position in the display region), the display control unit 107 displays objects such as a thumbnail image of the corresponding content. In other words, the display control unit 107 considers a cluster represented as a parent node of a leaf node corresponding to content data, and in a case where at least a portion of a cluster region is included in the region displayed as the execution screen, the display control unit 107 displays, on the display screen, a thumbnail image and the like of the corresponding content data.

In some cases, a position represented by position information corresponding to a content may not be included in a region displayed on the display screen. In such case, the display control unit 107 uses a node (cluster) including the corresponding content among the nodes notified by the node extraction unit 105 to display an object corresponding to this cluster on the display screen. At this occasion, a name given to the cluster is preferably used as the object corresponding to the cluster.

For example, explanation will be made using the example as shown in FIG. 13. In this example, the central position of the display screen is included in the node “Tokyo Observation Deck”, and a map around “Tokyo Observation Deck” is displayed in the display screen.

In such case, position information of contents corresponding to leaf nodes j to l is included in a region displayed in the display screen. Therefore, the display control unit 107 uses objects such as thumbnail images of the contents corresponding to the leaf nodes j to l to display the objects on the display screen.

On the other hand, position information of contents corresponding to leaf nodes g to i is not included in the region displayed in the display screen. Therefore, the display control unit 107 uses the node “Shinjuku Garden” extracted by the node extraction unit 105 and including these leaf nodes to display an object corresponding to this node.

Likewise, position information of contents corresponding to leaf nodes m to r is not included in the region displayed in the display screen. Therefore, the display control unit 107 uses the node “Chiba” extracted by the node extraction unit 105 and including these leaf nodes to display an object corresponding to this node.

On the other hand, position information of contents corresponding to leaf nodes a to f is not included in the region displayed in the display screen. Therefore, the display control unit 107 uses the node “Nagoya Metropolitan Area” extracted by the node extraction unit 105 and including these leaf nodes to display an object corresponding to this node.

The display control unit 107 can present, to a user, a list of contents that can be executed by the information processing apparatus 10 by performing the above display control, so that each content is displayed with a clustering granularity according to a distance from the central position of the display screen.

FIG. 21 shows an example of a display screen generated by the above processing. The display screen shown in FIG. 21 is generated using a tree structure different from the tree structure shown in FIG. 12 to FIG. 17. The tree structure used for generating the display screen is based on a feature space representing a location on a surface of the earth.

As shown in the figure shown in the center of FIG. 21, the display control unit 107 according to the present embodiment displays objects corresponding to content data in the display screen in such a manner that a display state of each object is changed according to a distance from the central position of the display screen.

In the case of the figure shown in the center of FIG. 21, thumbnail images 301 are used to display a content A and a content B, because position information of the content A and the content B is included in the region displayed in the display screen. On the other hand, other contents that can be used by the information processing apparatus 10 are displayed using objects 303 representing the corresponding clusters (hereinafter referred to as cluster objects), because position information of the other contents is not included in the region displayed in the display screen.

Further, the cluster object 303, i.e., the object representing the cluster, is arranged with a direction instruction object 305 such as an arrow as shown in FIG. 21.

In some cases, a plurality of cluster objects 303 may be arranged in the display screen. In this case, the display control unit 107 preferably adjusts display positions of the cluster object 303 and the direction instruction object 305 in such a manner that the cluster object 303 and the direction instruction object 305 do not overlap with each other.

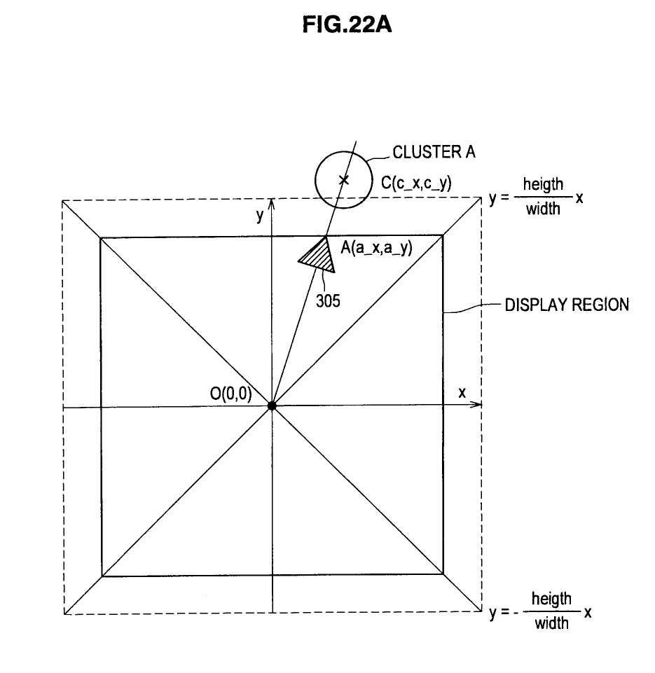

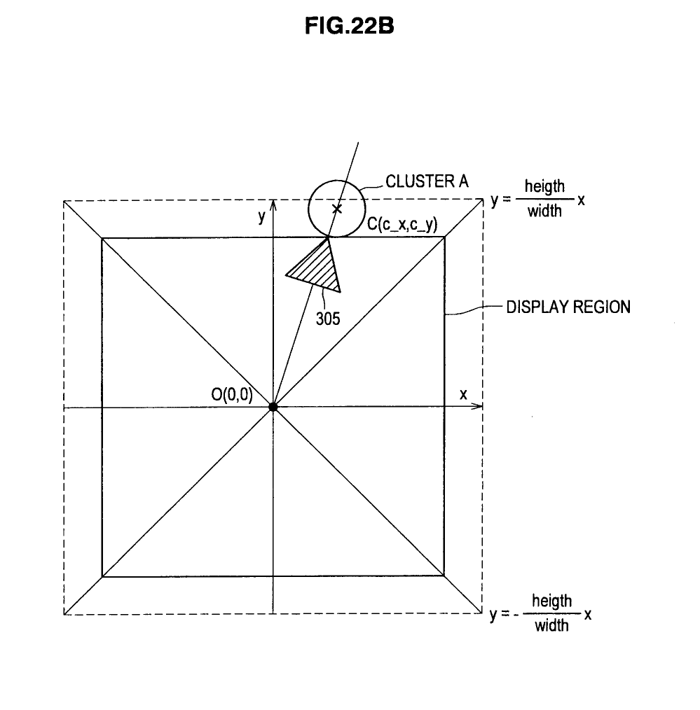

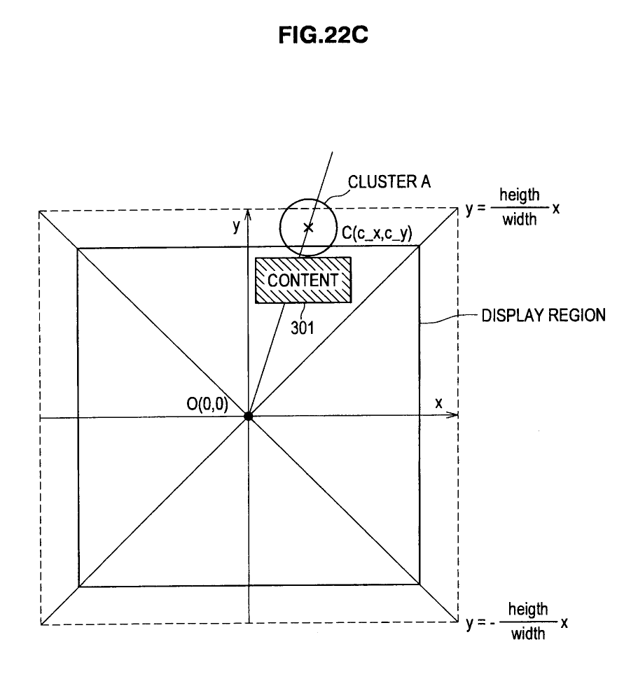

This direction instruction object 305 is displayed in the display screen in such a manner that the end of the direction instruction object 305 points to the central position of the corresponding cluster object 303. A drawing method of the direction instruction object 305 will be briefly explained with reference to FIG. 22A to FIG. 22C. A coordinate system as shown in FIG. 22A to FIG. 22C represents each position of a display screen with respect to an origin point in the center of the display screen.

FIG. 22A is a schematic figure illustrating an arrangement of a cluster A and a display region displayed in the display screen. As shown in FIG. 22A, when the direction instruction object 305 is added to a cluster object corresponding to the cluster A, the display control unit 107 first identifies a central position C (c_x, c_y) of a cluster region of the cluster A in a coordinate system for the display screen. Thereafter, the display control unit 107 considers a line connecting the origin point and the central position C, and arranges the direction instruction object 305 on this line. In this case, as shown in FIG. 22A, the end of the direction instruction object 305 is preferably arranged at an intersection point A (a_x, a_y) between a border line of the display region and the line connecting the origin point and the central position C.

Further, as shown in FIG. 22B, the display control unit 107 changes the size of the direction instruction object 305 according to a distance between the cluster A and the central position of the display screen (i.e., the origin point O). More specifically, the display control unit 107 sets the size of the direction instruction object 305 as follows: the shorter the distance between the cluster A and the origin point O, the larger the size of the direction instruction object 305. This display allows the user to intuitively recognize a distance between a cluster corresponding to the direction instruction object 305 and the central position of a display region.

Further, as shown in FIG. 22C, when at least a portion of the cluster region of the cluster A is included in the display region, the display control unit 107 displays the thumbnail images 301 instead of the cluster objects 303 and the direction instruction objects 305. Alternatively, even when a portion of the cluster region of the cluster A is included in the display region, the direction instruction object 305 may be left displayed.

In FIG. 22A to FIG. 22C, the display position and the size of the direction instruction object 305 have been explained. Regarding the cluster object 303, it is preferable to display the cluster object 303 at a position suggesting a direction of the cluster A and with a size suggesting a distance from the cluster.

For example, as shown in FIG. 22A, the display region can be divided into four partial regions by two lines representing diagonal lines. In this case, the cluster object 303 corresponding to each cluster is preferably arranged within a partial region to which the cluster belongs. For example, the cluster object 303 corresponding to the cluster A as shown in FIG. 22A is preferably arranged in a region represented by y≧(height/width)x and y≧−(height/width)x.

On the other hand, when the cluster object 303 as shown in FIG. 21 is an object made of a text array, the display control unit 107 preferably displays the characters in a size for suggesting a distance from the cluster. For example, the display control unit 107 preferably displays the characters in a smaller size when the distance from the cluster is large, and displays the characters in a larger size when the distance from the cluster is short.

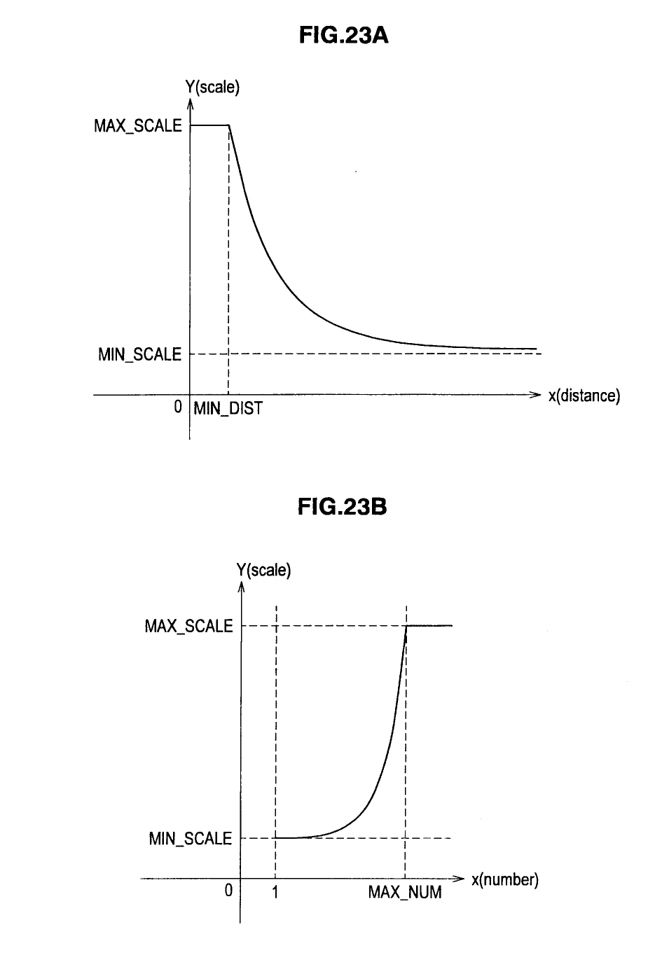

In this case, the display control unit 107 can use any method to determine the specific sizes of the cluster objects 303 and the direction instruction objects 305. For example, the display control unit 107 may use a function as shown in FIG. 23A to determine the specific sizes.

In the function shown in FIG. 23A, an X coordinate represents a pixel distance between a central position of a display screen and a center of a cluster, and a Y coordinate represents a display magnification rate of a cluster object and a direction instruction object.

In this example, the display control unit 107 determines a display magnification rate Y according to the expression 151 and the expression 152 as follows.

$$\begin{matrix} [ Mathematical Expression 3 ] & \\ ( Where X \geq MIN\_DIST ) \\ Y = ( MAX\_SCALE - MIN\_SCALE ) \times MIN\_DIST \times \frac{1}{X} + MIN\_SCALE & ( Expression 151 ) \\ ( Where X < MIN\_DIST ) \\ Y = MAX\_SCALE & ( Expression 152 )\end{matrix}$$

As is evident from the above expressions, in a case where the distance from the center of the cluster is less than a predetermined threshold value (MIN_DIST), the display control unit 107 changes the display magnification rate to a maximum value (MAX_SCALE). In a case where the distance is equal to or more than the predetermined threshold value, the display control unit 107 changes the display magnification rate to 1/X of the maximum value.

Further, the display control unit 107 may determine the specific size of the cluster object 303 and the direction instruction object 305 according to the number of contents included in a cluster. In this case, the display control unit 107 may determine the specific size using the function as shown in FIG. 23B.

In the function shown in FIG. 23B, an X coordinate represents the number of contents included in a cluster, and a Y coordinate represents a display magnification rate of a cluster object and a direction instruction object.

In this example, the display control unit 107 determines a display magnification rate Y according to the expression 153 and the expression 154 as follows.

$$\begin{matrix} [ Mathematical Expression 4 ] & \\ ( Where 1 \leq X \leq MAX\_NUM ) \\ Y = \frac{( MAX\_SCALE - MIN\_SCALE )}{{( MAX\_NUM - 1 )}^{k}} \times {( X - 1 )}^{k} + MIN\_SCALE & ( Expression 153 ) \\ ( Where MAX\_NUM < X ) \\ Y = MAX\_SCALE & ( Expression 154 )\end{matrix}$$

In this example, a parameter k in the above expression 153 is a coefficient determining an inclination of the function. The parameter k may be set to any value according to an environment to which this method can be applied. As is evident from the above expression, in a case where the number of content included in the cluster is one, the display control unit 107 sets the display magnification rate to a minimum value (MIN_SCALE), and changes the display magnification rate based on the above expression 153 according to an increase in the number of contents included in the cluster.

An example of a display screen will be explained with reference back to FIG. 21.

Depending on the number of contents displayed in the display screen, many objects are displayed in the display screen, and the screen becomes complicated in some cases. Accordingly, when the number of objects displayed in the display screen increases, and the display control unit 107 determines that the display screen has become complicated, the display control unit 107 may further select the objects displayed on the display screen.

For example, the display control unit 107 can further select the objects according to a distance from a central position of a display screen, a size of a content, the number of contents included in a cluster, history information of a user regarding content viewing, presence/non-presence of various kinds of information associated with a content and an order thereof, and the like.

When the number of cluster objects 303 displayed in the display screen becomes complicated, the display control unit 107 may make a plurality of cluster objects 303 corresponding to clusters in the same level into one cluster object 303 and display the cluster object 303.

A determination as to whether the display screen has become complicated is made by any method. For example, the display control unit 107 may make a determination based on whether the number of objects displayed in the display screen is more than the predetermined threshold value.

In some cases, a user who sees the display screen selects a thumbnail image 301 of a displayed content by clicking or tapping the thumbnail image 301. In such case, the display control unit 107 may switch the display screen in order to display metadata of an explanatory text associated with the selected content according to the display screen and display an explanatory text. On the other hand, when the selected content is a reproducible content such as a motion picture content, the content may be reproduced.

In some cases, a user may enlarge or reduce a display region without changing a central position of a display screen. For example, when the user performs zoom-out processing, the display control unit 107 displays, on the display screen, a thumbnail image 301 of a content coming into the display region. With this processing, the sizes of the cluster objects 303 and the direction instruction objects 305 are changed according to the zoom level.

On the contrary, in some cases, a user may perform zoom-in processing. In this case, in response to the zoom-in processing, the display control unit 107 changes, from the thumbnail image 301 to the cluster object 303, an object of a content whose position corresponding to position information no longer exists in a new display screen.

Further, the display control unit 107 may change a granularity of a cluster displayed as the cluster object 303 in response to enlarging/reducing processing. Accordingly, it is possible to let the user know that a large change occurs in a distance to a cluster in response to enlarging/reducing processing.

For example, when zoom-out processing is performed in the figure shown in the center of FIG. 21, thumbnail images 301 corresponding to contents that have come into the display region (for example, a cluster “Mt. Fuji”, a cluster “Kawasaki”, and a cluster “Yokohama”) are displayed in the display screen. The figure shown in the center of FIG. 21 shows cluster objects 303 of clusters in the same level, i.e., “Hokkaido” and “Tohoku”, which are displayed together. In this case, since the complexity of the screen is solved by zoom-out, the objects are no longer displayed together but are displayed individually. Further, since the scale of the screen is changed due to the zoom-out processing, the display control unit 107 changes the granularity so as to change a cluster displayed as “Western Japan” to a cluster “Nagoya”, i.e., a cluster in a lower level.

On the other hand, when zoom-in processing is performed in the figure shown in the center of FIG. 21, the content B is no longer located in the display screen, and the state of the object changes from the thumbnail image 301 to the cluster object 303. Further, since the scale of the screen is changed due to the zoom-in processing, the display control unit 107 changes clusters separately displayed as “Kawasaki” and “Yokohama” to “Kanagawa”, i.e., a cluster in an upper level.

A determination as to whether the granularities of clusters are to be changed or not can be made by any method. For example, the display control unit 107 may determine whether the granularities of clusters are to be changed or not according to the following method.

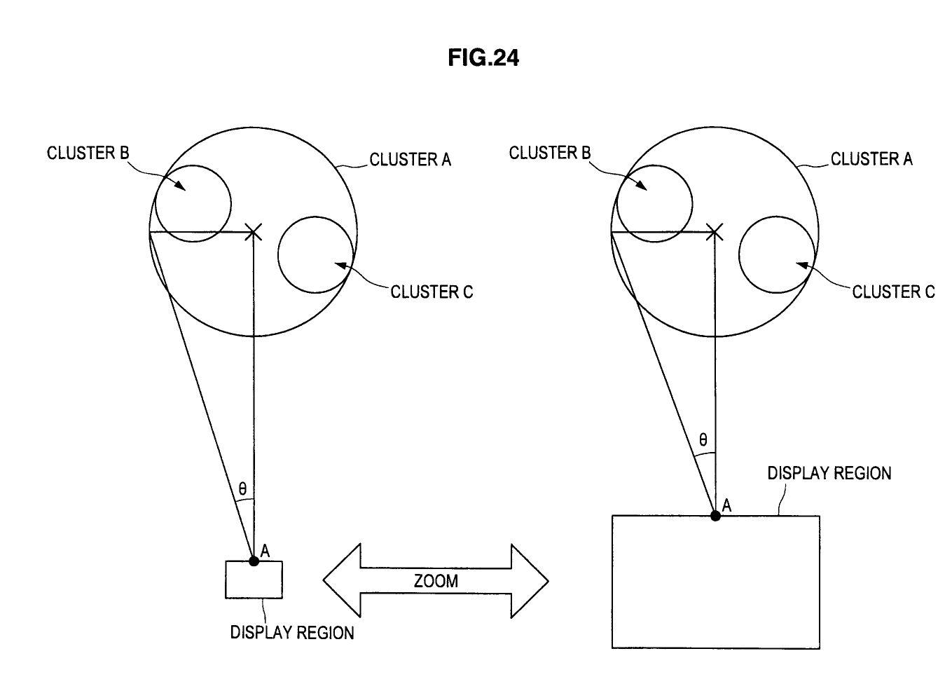

For example, as shown in FIG. 24, the display control unit 107 identifies a point A closest to a cluster in question in a display region, and calculates an angle θ shown in FIG. 24 with respect to this point A as a start point. In this case, when the magnitude of the angle θ becomes larger than a predetermined threshold value after enlarging/reducing processing, the display control unit 107 may reduce the cluster granularities by dividing the clusters. For example, in FIG. 24, a display region as shown in the figure on the left side is set, and a cluster A is displayed in the display region. During enlarging processing, the display region changes as shown in the figure on the right side. In this example, when the angle θ in the figure becomes equal to or more than the predetermined threshold value, the display control unit 107 may display a cluster B and a cluster C in place of the cluster A.

On the other hand, in some cases, a user may select a direction instruction object 305 displayed in the display screen. In this case, first, the display control unit 107 identifies which cluster corresponds to the selected direction instruction object 305. Subsequently, the display control unit 107 identifies a cluster central position of the identified cluster based on cluster data, and changes the screen so that such position is arranged in the center of the display screen. Alternatively, the display control unit 107 may change the screen so that the central position of the cluster is not arranged in the center of the display screen but a position of a content closest to the cluster central position is arranged in the center of the display screen. When the screen is changed as above, the display control unit 107 preferably determines a scale of an execution screen (for example, a map) so that all clusters (or contents) included in the new cluster are displayed within the display screen.

Alternatively, when the screen is changed as above, the display control unit 107 may request the node extraction unit 105 to perform node extraction processing again so as to display representing images in the display screen based on newly extracted nodes. In this case, examples of representing images include an image close to a central position of a cluster, an image close to a barycenter of content distribution within a cluster, and the like.

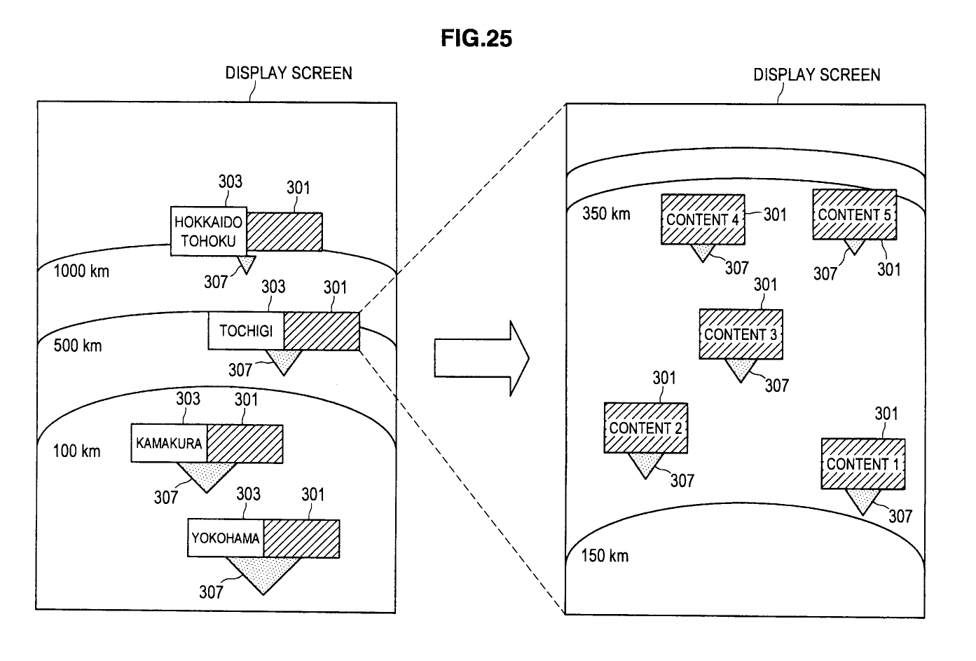

For example, as shown in FIG. 25, the display control unit 107 may show a distribution of objects corresponding to contents according to only distances from a specified position (for example, a current position). In this case, a distance shown in the figure represents a distance from the specified position. In this case, for each cluster, the display control unit 107 displays, on the display screen, a representing thumbnail image 301 of a content included in the cluster, a cluster object 303, and an object 307 representing a distance from the specified position. In this case, when a user selects a certain cluster (for example a cluster “Tochigi”), the display control unit 107 changes the display screen so that contents included in the cluster are displayed at a time.

As hereinabove explained, the display control unit 107 according to the present embodiment uses the extraction result provided by the node extraction unit 105 to cluster and display closely located contents as a clustering result, thus solving the issue of complicated display screen. Further, the display control unit 107 displays contents on the display screen as follows: the closer the content is located from a specified position, the finer the granularity of the content. Accordingly, information about contents located close to the specified position can be displayed in detail.

In the above explanation, when the display control unit 107 displays the contents in the display screen, the thumbnail images of the contents are displayed. However, the display control unit 107 may display, on the display screen, objects such as pins representing positions of contents, instead of thumbnail images of contents.

### <Display Screen Control Method>

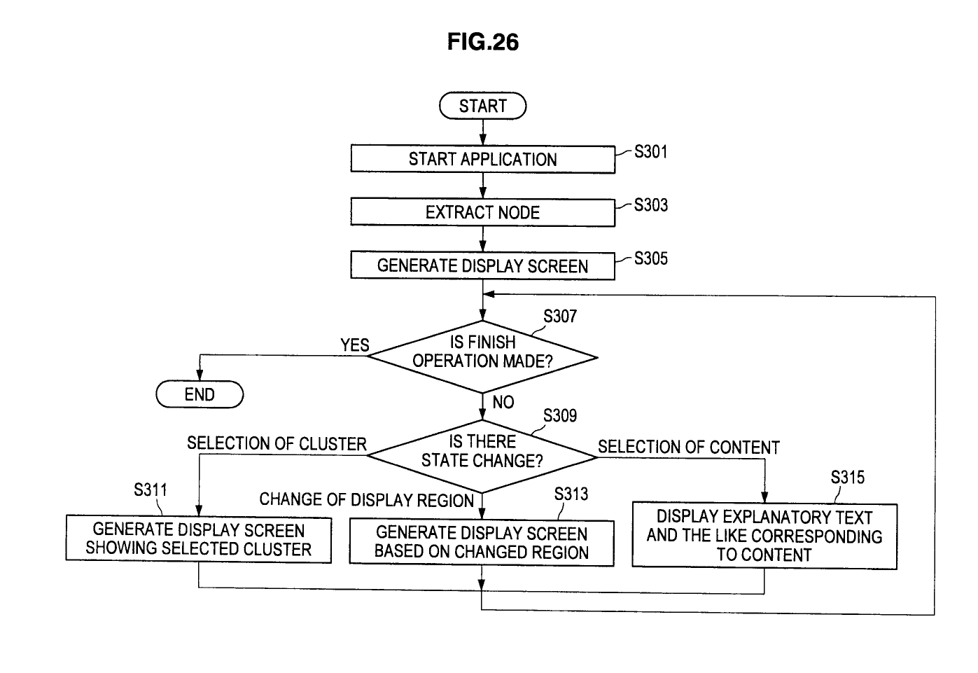

Subsequently, a flow of a display screen control method according to the present embodiment will be briefly explained with reference to FIG. 26. FIG. 26 is a flow diagram illustrating the display screen control method according to the present embodiment.

It is assumed that, before the following explanation, the tree structure generation unit 101 has generated a tree structure about contents that can be used by the information processing apparatus 10.

When a user performs operation for requesting start of a predetermined application, the display control unit 107 of the information processing apparatus 10 starts the specified application (step S301). Further, the extraction condition setting unit 103 sets an extraction condition used in node extraction processing based on various kinds of information notified by the input unit 111 or the GPS signal processing unit 113, and notifies the extraction condition to the node extraction unit 105. Subsequently, the node extraction unit 105 carries out the above-explained node extraction processing based on the notified extraction condition (step S303), and notifies the information about the extracted nodes to the display control unit 107.

Subsequently, the display control unit 107 uses the information about the extracted nodes to generate a display screen displayed on the display unit 109 (step S305), and displays the generated display screen in a predetermined region of the display unit 109.

Subsequently, the information processing apparatus 10 determines whether the user has performed a termination operation of the application (step S307). When the user has performed the termination operation, the information processing apparatus 10 terminates execution of the application.

On the other hand, when the user has not performed the termination operation, the information processing apparatus 10 determines whether the user has performed operation for changing the state of the display screen (step S309).

For example, in a case where the user has performed an operation to select a certain cluster (cluster object), the display control unit 107 generates a display screen for displaying a content of the selected cluster (step S311), and displays a predetermined region of the display unit 109. Thereafter, the information processing apparatus 10 returns back to step S307 to continue processing.

In a case where the user has performed an operation for changing the display region, the display control unit 107 generates a display screen based on the changed display region (step S313), and displays a predetermined region of the display unit 109. Thereafter, the information processing apparatus 10 returns back to step S307 to continue processing.

In a case where the user selects a certain content, the display control unit 107 performs processing for displaying, on the display screen, information such as explanatory texts corresponding to the selected content (step S315). Thereafter, the information processing apparatus 10 returns back to step S307 to continue processing.

By performing the above processing, the information processing apparatus 10 according to the present embodiment can display contents on the display screen so as not to make the display screen complicated.

### (Hardware Configuration)

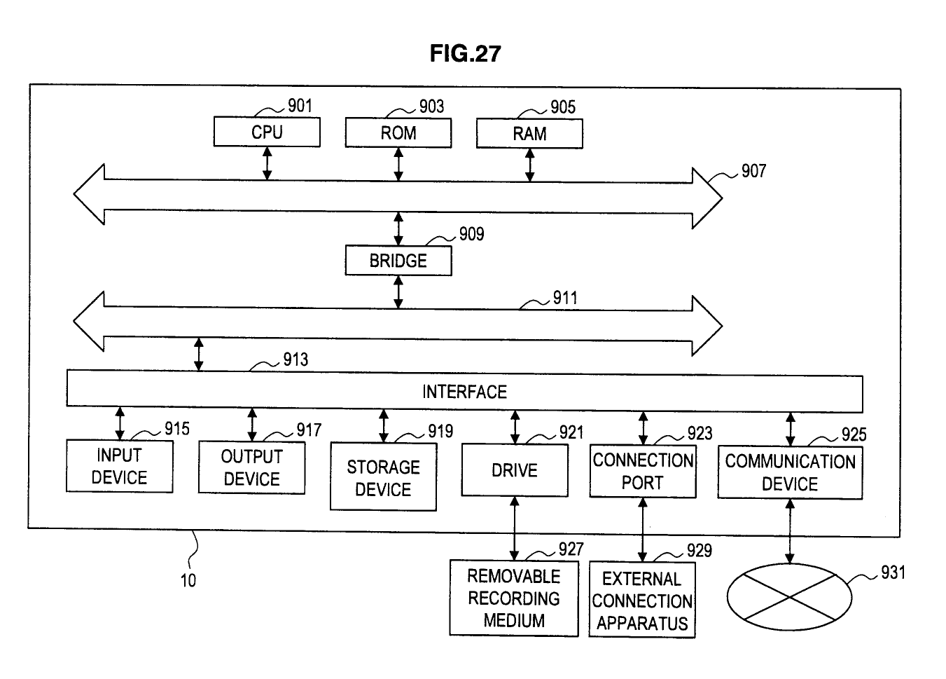

Next, the hardware configuration of the information processing apparatus 10 according to the embodiment of the present invention will be described in detail with reference to FIG. 27. FIG. 27 is a block diagram for illustrating the hardware configuration of the information processing apparatus 10 according to the embodiment of the present invention.

The information processing apparatus 10 mainly includes a CPU 901, a ROM 903, and a RAM 905. Furthermore, the information processing apparatus 10 also includes a host bus 907, a bridge 909, an external bus 911, an interface 913, an input device 915, an output device 917, a storage device 919, a drive 921, a connection port 923, and a communication device 925.

The CPU 901 serves as an arithmetic processing apparatus and a control device, and controls the overall operation or a part of the operation of the information processing apparatus 10 according to various programs recorded in the ROM 903, the RAM 905, the storage device 919, or a removable recording medium 927. The ROM 903 stores programs, operation parameters, and the like used by the CPU 901. The RAM 905 primarily stores programs used in execution of the CPU 901 and parameters and the like varying as appropriate during the execution. These are connected with each other via the host bus 907 configured from an internal bus such as a CPU bus or the like.

The host bus 907 is connected to the external bus 911 such as a PCI (Peripheral Component Interconnect/Interface) bus via the bridge 909.

The input device 915 is an operation means operated by a user, such as a mouse, a keyboard, a touch panel, buttons, a switch and a lever. Also, the input device 915 may be a remote control means (a so-called remote control) using, for example, infrared light or other radio waves, or may be an externally connected device 929 such as a mobile phone or a PDA conforming to the operation of the information processing apparatus 10. Furthermore, the input device 915 generates an input signal based on, for example, information which is input by a user with the above operation means, and is configured from an input control circuit for outputting the input signal to the CPU 901. The user of the information processing apparatus 10 can input various data to the information processing apparatus 10 and can instruct the information processing apparatus 10 to perform processing by operating this input apparatus 915.

The output device 917 is configured from a device capable of visually or audibly notifying acquired information to a user. Examples of such device include display devices such as a CRT display device, a liquid crystal display device, a plasma display device, an EL display device and lamps, audio output devices such as a speaker and a headphone, a printer, a mobile phone, a facsimile machine, and the like. For example, the output device 917 outputs a result obtained by various processings performed by the information processing apparatus 10. More specifically, the display device displays, in the form of texts or images, a result obtained by various processes performed by the information processing apparatus 10. On the other hand, the audio output device converts an audio signal such as reproduced audio data and sound data into an analog signal, and outputs the analog signal.

The storage device 919 is a device for storing data configured as an example of a storage unit of the information processing apparatus 10 and is used to store data. The storage device 919 is configured from, for example, a magnetic storage device such as a HDD (Hard Disk Drive), a semiconductor storage device, an optical storage device, or a magneto-optical storage device. This storage device 919 stores programs to be executed by the CPU 901, various data, and various data obtained from the outside.

The drive 921 is a reader/writer for recording medium, and is embedded in the information processing apparatus 10 or attached externally thereto. The drive 921 reads information recorded in the attached removable recording medium 927 such as a magnetic disk, an optical disk, a magneto-optical disk, or a semiconductor memory, and outputs the read information to the RAM 905. Furthermore, the drive 921 can write in the attached removable recording medium 927 such as a magnetic disk, an optical disk, a magneto-optical disk, or a semiconductor memory. The removable recording medium 927 is, for example, a DVD medium, an HD-DVD medium, or a Blu-ray medium. The removable recording medium 927 may be a CompactFlash (CF; registered trademark), a flash memory, an SD memory card (Secure Digital Memory Card), or the like. Alternatively, the removable recording medium 927 may be, for example, an IC card (Integrated Circuit Card) equipped with a non-contact IC chip or an electronic appliance.

The connection port 923 is a port for allowing devices to directly connect to the information processing apparatus 10. Examples of the connection port 923 include a USB (Universal Serial Bus) port, an IEEE1394 port, a SCSI (Small Computer System Interface) port, and the like. Other examples of the connection port 923 include an RS-232C port, an optical audio terminal, an HDMI (High-Definition Multimedia Interface) port, and the like. By the externally connected apparatus 929 connecting to this connection port 923, the information processing apparatus 10 directly obtains various data from the externally connected apparatus 929 and provides various data to the externally connected apparatus 929.

The communication device 925 is a communication interface configured from, for example, a communication device for connecting to a communication network 931. The communication device 925 is, for example, a wired or wireless LAN (Local Area Network), Bluetooth (registered trademark), a communication card for WUSB (Wireless USB), or the like. Alternatively, the communication device 925 may be a router for optical communication, a router for ADSL (Asymmetric Digital Subscriber Line), a modem for various communications, or the like. This communication device 925 can transmit and receive signals and the like in accordance with a predetermined protocol such as TCP/IP on the Internet and with other communication devices, for example. The communication network 931 connected to the communication device 925 is configured from a network and the like, which is connected via wire or wirelessly, and may be, for example, the Internet, a home LAN, infrared communication, radio wave communication, satellite communication,

Heretofore, an example of the hardware configuration capable of realizing the functions of the information processing apparatus 10 according to the embodiment of the present invention has been shown. Each of the structural elements described above may be configured using a general-purpose material, or may be configured from hardware dedicated to the function of each structural element. Accordingly, the hardware configuration to be used can be changed as appropriate according to the technical level at the time of carrying out the present embodiment.

It should be understood by those skilled in the art that various modifications, combinations, sub-combinations and alterations may occur depending on design requirements and other factors insofar as they are within the scope of the appended claims or the equivalents thereof.

The present application contains subject matter related to that disclosed in Japanese Priority Patent Application JP 202009-277082 filed in the Japan Patent Office on Dec. 4, 2009, Japanese Priority Patent Application JP 202009-277081 filed in the Japan Patent Office on Dec. 4, 2009, the entire content of which is hereby incorporated by reference.

What is claimed is:

1. A display screen control method, comprising the steps of:
generating a tree structure in which a leaf node represents content data associated with position information, serving as metadata, representing a location of a feature space defined based on a predetermined feature quantity, and a set of nodes whose distance in the feature space satisfies a predetermined condition is defined as a parent node of the nodes satisfying the predetermined condition;
when any position information serving as a reference is specified, identifying a node in the tree structure to which the specified position information belongs;
extracting, according to a position of the identified node in the tree structure, one or a plurality of nodes, other than the node to which the reference position information belongs, from among the nodes in the tree structure; and
using a node extraction result obtained in the step of extracting the node to display an object corresponding to the content data at a position in a display screen according to the position information,
wherein in the step of identifying the node and in the step of extracting the node, a position corresponding to a center of the display screen is used as the position information serving as the reference,
in the step of displaying the object, in a case where there is content data in which a position corresponding to the position information is out of a range displayed in the display screen, a node including the content data located out of the range is selected from among the extraction result, and
an object corresponding to the selected node is displayed as an object of the content data located out of the range.

2. The display screen control method according to claim 1,
wherein in the step of displaying the object, in a case where the object corresponding to the node is displayed, a direction instruction object is displayed together with the object corresponding to the node, the direction instruction object indicating a direction of a position corresponding to the position information associated with the node.

3. The display screen control method according to claim 2,
wherein in the step of displaying the object, in a case where the direction instruction object is selected by user operation, the display screen is changed so that a central position of the node corresponding to the direction instruction object or a position of the content data located at a position closest to the central position of the node is arranged in the center of the display screen.

4. The display screen control method according to claim 3,
wherein in the step of displaying the object, a size of a region displayed in the display screen is determined so that other nodes or content data included in the node are all displayed within the display screen.

5. The display screen control method according to claim 1,
wherein in the step of displaying the object, the node selected from among the extraction result is changed according to a size of a region displayed in the display screen.

6. The display screen control method according to claim 2,
wherein sizes of the direction instruction object and the object corresponding to the node are determined according to a distance between the node and a position corresponding to the center of the display screen or the number of content data or other nodes included in the node.

7. A graphical user interface comprising:
a display region for displaying an execution screen of an application for displaying, at a display position corresponding to position information, an object corresponding to content data associated with the position information, serving as metadata, representing a location of a feature space defined based on a predetermined feature quantity,
wherein the content data are clustered into one or a plurality of groups based on the position information in advance, and
a display state of the object in the execution screen changes according to a clustering result and a distance between a position corresponding to the position information and a central position of the execution screen.

8. An information processing apparatus comprising:
a tree structure generation unit that generates a tree structure in which a leaf node represents content data associated with position information, serving as metadata, representing a location of a feature space defined based on a predetermined feature quantity, and a set of nodes whose distance in the feature space satisfies a predetermined condition is defined as a parent node of the nodes satisfying the predetermined condition; and
a node extraction unit that, when any position information is specified, identifies a node in the tree structure to which the specified position information belongs, and extracts, according to a position of the identified node in the tree structure, one or a plurality of nodes, other than the node to which the specified position information belongs, from among the nodes in the tree structure.

9. The information processing apparatus according to claim 8,
wherein the node extraction unit extracts, from among the nodes in the tree structure, all child nodes of the identified node and nodes, other than the identified node, branching from a parent node of the identified node.

10. The information processing apparatus according to claim 9,
wherein the node extraction unit newly adopts, as a new target node, a parent node having a child node, other than the identified node, branching from the identified node and a parent node of the identified node, and further extracts a node, other than the target node, branching from a parent node of the target node.

11. The information processing apparatus according to claim 10,
wherein the node extraction unit repeats node extraction until the target node becomes a root node.

12. The information processing apparatus according to claim 9,
wherein in a case where the specified position information belongs to a plurality of nodes in the tree structure, the node extraction unit adopts, as a node to which the specified position information belongs, a node located at a deepest position with respect to the root node from among the plurality of nodes.

13. The information processing apparatus according to claim 9,
wherein in a case where the specified position information further includes information for specifying a region in the feature space, the node extraction unit changes an extracted node according to a size of an area of the region.

14. The information processing apparatus according to claim 8,
wherein the feature space is a space representing a location on a surface of a sphere defined by a latitude and a longitude.

15. The information processing apparatus according to claim 8,
wherein the feature space is a space defined based on a feature quantity for specifying a location on a plane.

16. The information processing apparatus according to claim 8,
wherein the feature space is a space defined based on a feature quantity for specifying a time.

17. An information processing method, comprising the steps of:
generating a tree structure in which a leaf node represents content data associated with position information, serving as metadata, representing a location of a feature space defined based on a predetermined feature quantity, and a set of nodes whose distance in the feature space satisfies a predetermined condition is defined as a parent node of the nodes satisfying the predetermined condition;
identifying a node in the tree structure to which any specified position information belongs; and
extracting, according to a position of the identified node in the tree structure, one or a plurality of nodes, other than the node to which the specified position information belongs, from among the nodes in the tree structure.

18. A program for causing a computer to realize:
a tree structure generation function for generating a tree structure in which a leaf node represents content data associated with position information, serving as metadata, representing a location of a feature space defined based on a predetermined feature quantity, and a set of nodes whose distance in the feature space satisfies a predetermined condition is defined as a parent node of the nodes satisfying the predetermined condition; and
a node extraction function for, when any position information is specified, identifying a node in the tree structure to which the specified position information belongs, and extracting, according to a position of the identified node in the tree structure, one or a plurality of nodes, other than the node to which the specified position information belongs, from among the nodes in the tree structure.
